(19) United States
(12) Patent Application Publication
(10) Pub. No.: US 2007/0226073 A1
(43) Pub. Date: Sep. 27, 2007

(54) Garment development and production system utilizing a standardized garment data format

(76) Inventor: Kenneth Kuk-Kei Wang, Hong Kong (HK)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/726,531

(22) Filed: Mar. 22, 2007

Related U.S. Application Data
(60) Provisional application No. 60/785,124, filed on Mar. 22, 2006.

(51) Int. Cl. G06Q 30/00

(52) U.S. Cl. 705/26

(57) ABSTRACT

A garment development and production system includes a garment data format (GDF) browser that communicates garment data with a garment component knowledge database (GCK-DB). The GDF browser includes a graphical user interface (GUI) that displays a classification tree section, a parameter section, a visualization section, and a comments section. In particular, the GDF browser allows the members of the garment supply chain to share garment data and to collaborate with each other as needed throughout the garment development process. In addition, the garment development and production system includes an annotations application, a position verification system (PVS) application, and a garment visualization system (GVS) application that enables the members of the garment supply chain to collect, manipulate, and share garment data and knowledge at any time during the garment development process.

### CROSS-REFERENCE TO RELATED APPLICATION

This application claims the benefit of U.S. Provisional Application No. 60/785,124, filed Mar. 22, 2006, which is incorporated herein by reference.

### TECHNICAL FIELD

The present invention is generally directed to a system for producing garments that includes storing and manipulating garment data, particularly in the course of the design of a garment. Specifically, the present invention is directed to the communication of electronic garment data using a standardized graphical user interface (GUI). More specifically, the present invention is directed to a standardized platform for enabling the interactive communication of garment data throughout a garment manufacturing supply chain thereby facilitating garment development.

### BACKGROUND OF THE INVENTION

Development of new garment products requires a significant amount of knowledge concerning the different aspects or components comprising the garment. Unfortunately, this knowledge is not in a form that can be readily communicated between each member of the garment supply chain, thus a significant amount of knowledge remains unshared. This knowledge can be made more explicit, or readily available, if there are understandable formats to contain the components of the garment. Knowledge is created every time a product is developed, unfortunately this knowledge is seldom passed in a meaningful way throughout the supply chain—upstream to the sales people and downstream to the production operatives. As such, this knowledge remains tacit, and the various members of the garment supply chain repeatedly have to seek such knowledge individually on their own. One reason knowledge is not passed on easily is that different communication links in the supply chain present the knowledge in varying formats. In addition, the different members of the supply chain may interpret a set of data in different ways, or a member may make changes to a set of data in a specific way, but fails to communicate the changes to others in the manufacturing supply chain. As such, communication of garment data or knowledge between members of the garment supply chain is often frustrated by the inconsistent arrangement or format of such data and knowledge.

The product development cycle in the garment industry involves the brand designer's conception, the merchandiser's interpretation and the sampling/production department's execution or production of a garment. The market for garments often dictates that the garment specifications change to suit price, quality and delivery constraints identified during the garment order negotiation stage. For example, when garment purchase orders are placed, the capability and capacity considerations inherent to the supply chain may require changes to those orders so as to meet availability constraints. Ambiguous and/or changing garment specifications lead to incorrect or erroneous interpretations by the supply chain members that may adversely affect the manufacturing of the completed garment. In addition to the continually changing constraints, the garment development process is further complicated as the customers' subjective “like and dislike” of the garment also need to be considered by the supply chain members.

Additionally, the members of the garment supply chain, including the brands, wholesalers, sourcing agents, manufacturers, suppliers, logistic providers and retailers are often dispersed throughout different parts of the world. As such, communication conducted to discuss product development is seldom in person. Thus, to overcome the lack of in person communication, physical garment samples are often shipped between the supply chain members. However, the shipment of such samples is time consuming and often slows the development time of the garment, which is unwanted. Furthermore, the use of language by the supply chain members to describe aspects of a garment is often inadequate for characterizing the specific attributes of a garment. Unfortunately, there is a lack of visualization tools to capture and present images of garments dressed on the correct dress form. Nor are there visualization tools that allow images to be captured of garments oriented at different angles in three dimensions or images to be captured of garment component parts in two dimensions. Thus, due to the deficiencies recited above, discussions among the various supply chain members often results in miscommunication, which impedes garment development.

Therefore, there is a need for a garment development and production system that utilizes a garment communication network having a garment data format (GDF) browser and GDF workstation for each member of the garment supply chain to view garment data. Furthermore, there is a need for a garment development and production system having a garment communication network that utilizes a garment component knowledge database to store knowledge and data related to the development of each component that comprises a garment. In addition, there is a need for a garment development and production system that maintains a garment communication network, which allows the members of the garment supply chain to access data stored at the garment component knowledge database, and to collaborate with one another regarding the accessed data using the GDF browser and/or the GDF workstation. Still yet, there is a need for a garment development and production system that provides a garment position verification system (PVS) application that enables the user to graphically superimpose a graphically rendered garment design upon a graphically rendered body form to analyze the fit of the garment. Additionally, there is a need for a garment development and production system that provides a garment visualization system (GVS) application that enables the user to capture images of the garment or garment components. There is also a need for a garment development and production system that includes an annotations application that includes a plurality of communication tools that facilitates the collaboration between each of the members of the garment supply chain.

### SUMMARY OF THE INVENTION

In light of the foregoing, it is a first aspect of the present invention to provide a garment development and production system utilizing a standardized garment data format.

One aspect of the present invention provides for a graphical user interface including a display and a selection device, a method of providing and selecting from a browser on the display, the method comprising retrieving a classification tree section, a parameters section, and a visualization section for the browser; displaying the classification tree section on the display, the classification tree including at least one garment component entry associated with a garment component image, an attribute and an attribute value maintained at a database; displaying the parameters section on the display; displaying the visualization section on the display; and receiving a first selection signal indicative of the selection device pointing at a selected garment component entry included at the classification tree; wherein in response to the first selection signal, the parameters section displays the attribute and the attribute value, and the visualization section displays the garment component image.

Another aspect of the present invention provides a graphical user interface including a display and a selection device, a method of providing and selecting from a browser on the display, the method comprising retrieving an imaging section, an image list section, and a body form image; displaying the imaging section on the display; displaying the body form image in the imaging section, wherein at least one reference line is located a first position with respect to the body form image; displaying the image list section, the image list section including at least one garment component entry associated with a garment image maintained at a garment component knowledge database; receiving a first selection signal indicative of the selection device pointing at a selected garment component entry, wherein in response to the first selection signal, the imaging section displays the selected garment image; and positioning the garment image upon the body form image.

In still another aspect of the present invention provides a method for collaborating and sharing garment data among a plurality of members of a garment supply chain comprising providing a primary data repository, wherein each of the members communicate with the data repository via a browser; importing a garment image into the browser; storing the garment image at the repository; positioning the garment image with respect to a body form image retrieved from the data repository; and storing the positioned garment and body form image at the repository as a garment data file.

### BRIEF DESCRIPTION OF THE DRAWINGS

These and other features and advantages of the present invention will become better understood with regard to the following description, appended claims, and accompanying drawings wherein:

FIG. 1 is a block diagram showing a garment communication network for a garment development and production system that enables members of a garment supply chain to communicate garment data and collaborate as needed throughout the garment production process according to the concepts of the present invention;

FIG. 2, which can be seen in detailed FIGS. 2A and 2B, is a screen view showing a garment data format (GDF) browser for use in the garment development and production system that includes a classification tree section, a parameters section, a visualization section, and a comments section according to the concepts of the present invention;

FIG. 3A is a screen view showing a concept sketch that is associated with a new order inquiry (NOI) shown in FIG. 3B according to the concepts of the present invention;

FIG. 3B is a screen view showing the new order inquiry (NOI) sheet according to the concepts of the present invention;

FIG. 4 is a screen view of a display maintained by a GDF workstation according to the concepts of the present invention;

FIG. 5 is a screen view of an annotation application for use with the GDF browser according to the concepts of the present invention;

FIG. 6 is a screen view of a comment made within the GDF browser using the annotation application according to the concepts of the present invention;

FIG. 7 is a flowchart showing the process steps taken when using a garment visualization system (GVS) application according to the concepts of the present invention;

FIG. 8, which can be seen in detailed FIGS. 8A-8C, is a screen view showing a position verification system (PVS) application according to the concepts of the present invention;

FIG. 9 is a screen view of the PVS application showing the ability to arrange a garment component with regard to a body form according to the concepts of the present invention;

FIGS. 10A and 10B present a block diagram showing the relationship between the various browsers, GDF workstations and applications, and the purposes fulfilled by them during the garment development process according to the concepts of the present invention;

FIG. 11 is a screen view of the GDF workstation according to the concepts of the present invention;

FIG. 12, which can be seen in detailed FIGS. 12A-12B, is a screen view of a fabric requisition worksheet according to the concepts of the present invention;

FIG. 13, which includes detailed FIGS. 13A and 13B, 13A-B presents a screen view of a sewing control worksheet according to the concepts of the present invention;

FIG. 14 is a screen view of a production worksheet according to the concepts of the present invention; and

FIG. 15 is a flowchart showing the steps taken by members of the garment supply chain when using the GDF browser, the annotation application, the GVS application, and the PVS application to develop and produce a garment according to the concepts of the present invention.

### BEST MODE FOR CARRYING OUT THE INVENTION

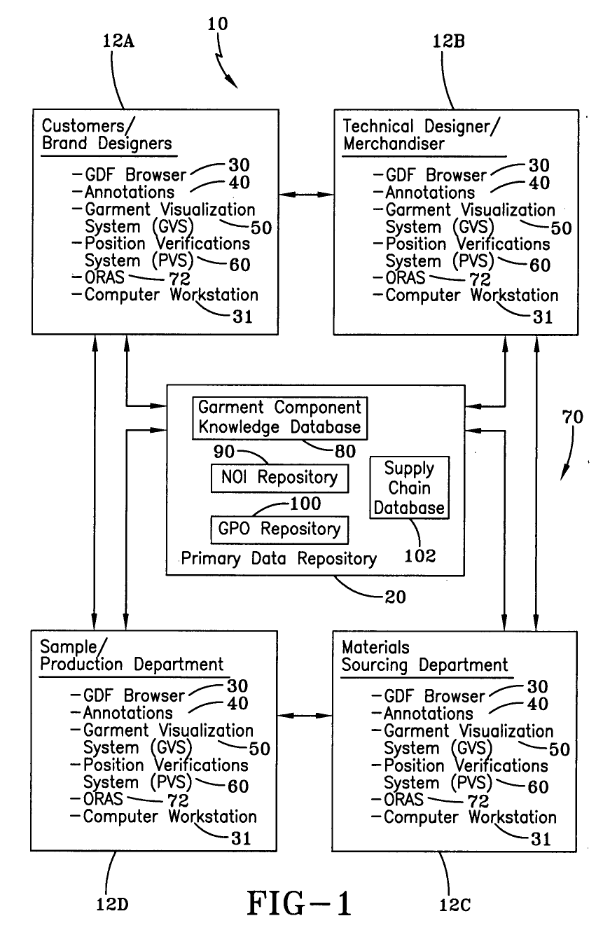

A garment development and production system 10, shown in FIG. 1 of the drawings, provides a standardized group of purpose-driven user interfaces, associated applications, and databases, which coact to provide a platform for communicating garment information interactively among members 12A-D of a garment supply chain that include the customer or brand designer 12A, the designer or merchandiser 12B, the materials sourcing department 12C, and the sample/production department 12D. In particular, the members 12A-D of the garment supply chain may collaborate and/or share garment data during any phase of the garment development and production process, which may include, but is not limited to: garment sales preparation, garment design development, and garment production control. In particular, the garment development and production system enables garment data to flow seamlessly from the initial inquiry stages of garment development, where the component specifications of the garment are still evolving, to the garment production control stages where the specifications of the garment components are required to be exact. It should also be appreciated that while the particular features of the garment development and production system 10 will be presented in detail in the discussion below, further background details of the system may be found in U.S. Patent Application Publication No. 2004/0186611 and PCT Publication No. WO 03/079836, the contents of which are incorporated herein by reference.

Before discussing the technical aspects of the present invention, the particular function of each member 12A-D of the garment supply chain will be first set forth, so as to facilitate the understanding of the garment development and production system 10 presented herein. The customer or brand designer 12A is responsible for developing a particular concept for a garment, such a coat, pant, or shirt, or for a collection of garments to be manufactured. The technical designer or merchandiser 12B takes the concept from the brand designer 12A and makes a technical sketch based on the brand designer's concept, and establishes what garment components are needed in order to produce a manufacturable garment. Next, the materials sourcing department 12C is responsible for obtaining and inventorying the materials used to produce the garments established by the merchandiser. Finally, the sample/production department 12D is responsible for developing garment samples embodying the technical sketch and for producing finished garments. Throughout the garment development process each member 12A-12D may require the knowledge or expertise of another member, as such, it is the facilitation of this knowledge or expertise as well as other processes, which is the basis for the discussion that is presented below. Moreover, it should be appreciated that the term “garment” as used herein is defined to include garments, garment components, or garment fabrics that are electronically represented within the garment development and production system 10 to be discussed.

In particular, the system 10 stores and communicates data via a group of databases and knowledge bases, identified as a primary data repository 20. The primary data repository 20 is configured to utilize a standardized data format, referred to herein as the garment data format (GDF), which allows each member 12 of the garment supply chain to communicate garment data among each other, as well as to collaborate during the garment development process. To enable such functionality, the primary data repository 20 supplies garment data to a garment data format browser, or GDF browser 30, maintained by each of the supply chain members 12A-D. And although only four members are specifically described herein, it will be appreciated that any member of the supply chain not specifically identified herein could utilize the browser 30 and make contributions as needed. The GDF browser 30, comprises an interactive graphical user interface (GUI) that enables the user to view the garment as well as its various components, and which allows the user to make comments related thereto, which can be shared with others throughout the garment development process.

In addition to the GDF browser 30, the garment development and production system 10 also includes a GDF workstation 31. The GDF workstation 31 comprises a computer system, a viewable display, as well as suitable input devices such as a keyboard and mouse that presents various GUI based screens that allow users to interact and manipulate data stored at the primary data repository 20 in a desired manner. In particular, the GDF workstation 31 allows a member 12 and other approved users to process work, which may be in the form of various spreadsheets and worksheets for example.

Moreover, the garment development and production system 10 also provides various application tools that further support or enhance the function of the GDF browser 30 and the GDF workstation 31. In one aspect, the applications may include an annotations application 40, a garment verification system (GVS) application 50, and a position verification system (PVS) application 60. As such, because garment data is communicated in a standardized and purposeful manner via the primary data repository 20, the GDF browsers 30, the GDF workstations 31, and the various applications 40,50, and 60; the various processes performed by the manufacturing supply chain members 12 are facilitated. For example, the GDF browser 30, the GDF workstation 31, and applications 40-60 may be used to facilitate the following tasks, including, but not limited to: product development, order negotiations, product control, logistics control, retail control and personalized apparel information, and the collection of garment purchase orders. In other words, the primary data repository 20, the GDF browser 30 and applications 40-60 allow garment related data to be referenced, visualized, compared, annotated, assessed, queried, and discussed interactively, collaboratively, and transparently by the members 12A-D of the garment supply chain.

Thus, as shown in FIG. 1, the garment development and production system 10 incorporates a garment communication network 70 so that each member of the supply chain 12A-D is coupled to the primary data repository 20, while each member 12A-D is also coupled to every other member 12A-D of the supply chain. As such, the garment communication network 70 allows each member 12A-D using their dedicated GDF browser 30, GDF workstation 31, and supporting application tools 40-60 to communicate data to and from the primary data repository 20, and to collaborate with any desired member 12A-D of the garment supply chain.

In addition to the GDF browser 30, the GDF workstation 31, and the other applications 40, 50, 60 discussed above, an order registration/assignment system, or ORAS 72 is part of the system 10 and incorporated into the garment communication network 70. The ORAS 72 facilitates purpose driven communication between the workstation browser 31 and the primary data repository 20 throughout the garment development process. In order to establish relevancy concerning any relational database of the primary data repository 20, the user, such as the members 12A-D of the supply chain, define the purpose for accessing the information or for making an interactive communication, such as a collaboration. As such, the ORAS 72 facilitates the purpose driven aspects of the present system 10 through the utilization of an instruction and response system. To achieve such operation, the ORAS 72 allows each member of the garment supply chain 12A-D to control and operate their daily processes, procedures, and tasks by issuing instructions and receiving responses therefrom. For example, each member 12A-D oversees various departments in which each employee therewithin has his or her own role or scope of responsibility with regard to work to be performed. As such, each employee does his or her work, or assigns work (instruction) to his or her subordinates (response). As such, the particular department assigning the work must provide an accurate and sufficient explanation of the task to be accomplished so that the employee can perform the work. Specifically, expectations on the target price, delivery date, and quality level must also be clearly communicated to the responsible employees. As such, ORAS 72 enables supply chain members 12A-D to accurately communicate such instructions between the various departments of the garment supply chain, and provides the necessary controls to facilitate the creation of a garment during the garment development process.

With regard to the production control phase of the garment production system 10, it includes a materials control component, which relates to the procedure for purchasing fabric, and a sewing construction control component that relates to the procedure of sewing factory loading. Thus, the ORAS 72, which is enabled by the GDF workstation 31, utilizes a workflow, which will be discussed in detail below, that lists all of the processes required, the procedures to be performed, and lists operations and tasks that need to be accomplished. After the workflow is prepared, the user aggregates the work needed to be processed with regard to a particular process, procedure, or task. After the workload is aggregated, it is distributed to each relevant member 12A-D of the garment supply chain 12A-D, where the supervisors assign the work to the workforce.

Specifically, the primary data repository 20 comprises a garment component knowledge database, or GCK-DB 80, which is a knowledge database, such as that provided by ORACLE®, that is configured to store all the garment related component data in a data format that is compatible for access and display by the GDF browser 30 and the GDF workstation 31. In particular, the GCK-DB 80 is configured to maintain various databases of garment related data that can be accessed by the GDF browser 30 and the applications 40-60 in a manner to be discussed. For example, the GCK-DB 80 may include a materials database, a garment module database, a garment construction database, an embellishments database, and a washing and surface effects database, although any other database may be used with the GCK-DB 80. The materials database may include the digital data representations of garment fabric, garment trims, and garment accessories, whereas the garment module database may include categorization of body forms, such as body forms provided under the brand ALVAFORM®, categorization of garment types and silhouettes as overlay images, and GVS created garment images. The garment construction database may include categorization of garment modules, categorization of garment parts, and other garment related data utilizing garment sewing data (GSD). Next, the embellishments database may include the categories of embroidery, screen print, handicraft, while the washing/surface effects database may include the categories of fabrics, washing recipes, surface effect categories, surface effect overlay sheet, and wash bands. It should be appreciated that the databases recited above may include any desired categorization or data.

Also maintained by the data repository 20 is a new order inquiry (NOI) repository 90. The NOI repository 90 comprises a global data storage location that is configured to store all new order inquiries (NOI), and associated inquiry data that is collected during the inquiry stage of the garment manufacturing process, which will be discussed in detail later. In addition, the primary data repository 20 may also include a GPO (garment purchase order) repository 100, which comprises a global storage location that is configured to store all the garment purchase order (GPO) data. A supply chain database 102 is also maintained by the primary data repository 20, which provides a location for the storage and retrieval of each individual member 12A-D of the garment supply chain, and various other information associated therewith. It should also be appreciated that the GCK-DB 80, the NOI repository 90, the GPO repository 100, and the supply chain database 102 are relational databases that define information based on its purpose, such as sales preparation, garment development and production control for example. The function of each of the components 80, 90, 100, 102 of the primary data repository 20 within the garment development and production system 10 will be made apparent in the discussion that follows.

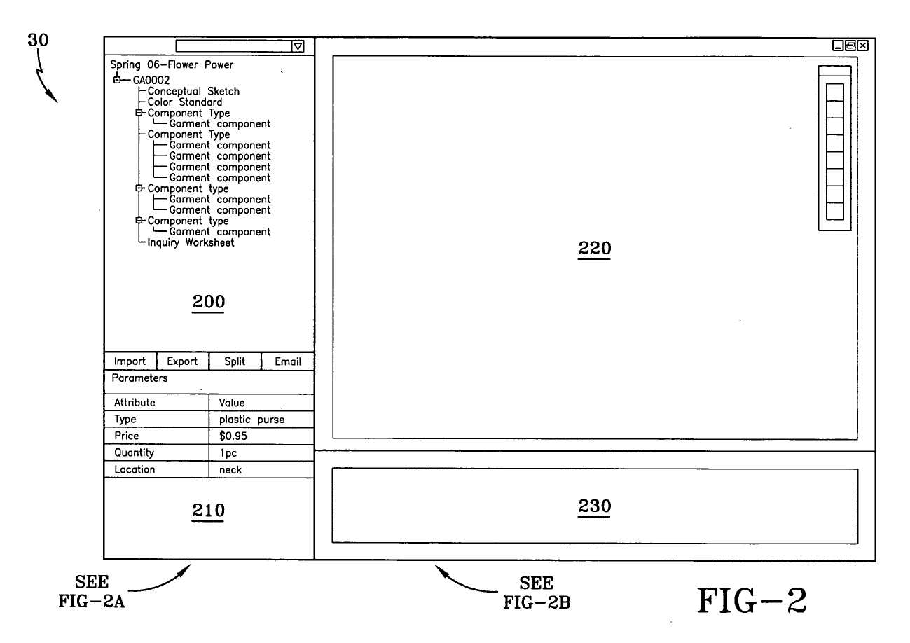

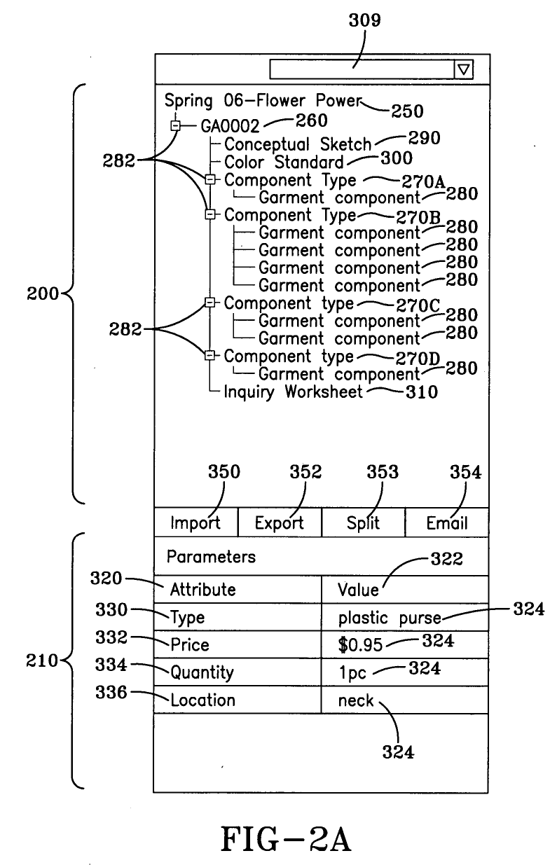

To access the garment data maintained by the primary data repository 20, the GDF browser 30, shown in FIGS. 2, 2A and 2B is utilized. It should be appreciated that the GDF browser 30 comprises a graphical user interface (GUI) that is rendered from software executed on a suitable computer system, such that the GDF browser 30 is presented upon a viewable display, such as an LCD (liquid crystal display) for example. As such, the members of the garment supply chain 12A-D may interact with the GDF browser 30 via any suitable input device, such as a mouse and/or keyboard for example. The graphical user interface (GUI) of the GDF browser 30 and the GDF workstation 31 comprises four data sections that include: a classification tree section 200, a parameters section 210, a visualization section 220, and a comments section 230. As will be discussed in more detail, these four data sections 200,210,220,230 allow the supply chain members 12A-D to establish and alter garment specifications, view the garment in various stages of completion, and enable the supply chain members to collaborate as the garment progresses from conception to production.

The classification tree 200 of the GDF browser 30 comprises a subordinated tree-branch structure in which various garment data files or components are located within hierarchically arranged collection identifiers, garment identifiers, and component type identifiers to be discussed below. In addition, the garment data files or components displayed in the classification tree 200 represent garment data, such as garment images, sketches, photos, text-based data, and any other garment related information, which is obtained from the primary data repository 20 previously discussed. Specifically, the classification tree 200 includes a garment collection identifier 250 that identifies a particular group or collection of one or more garments that are associated with each other by a common theme, styling, or other characteristic. The garment collection identifier 250 may comprise any alphanumeric characters that uniquely identifies the particular collection to which particular garments are related. For example, the garment collection identifier 250 may indicate “Spring 06-Flower Power” to communicate to the user that the garments contained within the collection identifier 250 are associated with the spring 2006 flower power design collection.

Contained within each garment collection 250 are one or more individual garments identified by a garment identifier 260 that may comprise any alphanumeric characters that uniquely identifies the particular garment that is contained within the garment collection identifier 250. For example, an individual garment may be identified by the code “GA0002” that is associated with a particular coding scheme that is familiar with the members 12A-D of the garment supply chain. Within the garment identifier 260, are various garment component identifiers 270A-D that make up the garment. For example, the garment component identifier may include but is not limited to a fabric component identifier 270A, a trims component identifier 270B, an embroidery component identifier 270C, and a screen print component identifier 270D for example. However, these garment component identifiers 270A-D should not be construed as limiting, as other components may be included within a particular garment identifier 260 depending on the garment being developed. For example, the garment component identifier 270 may include: embellishments components, a garment construction component, garment modules, materials components, and washing and finishing components may be provided.

Each component identifier 270 includes one or more components 280 that comprise the garment identified by the garment identifier 260. For example, the components 280 may comprise main fabric, crochet flower, button, or any other desired component that is used to form the garment identified by the garment identifier 260. That is, the garment identified by the garment identifier 260 is comprised of the components 280 found within the component identifiers 270 of the classification tree 200. As such, when the particular garment component 280 is selected by the user, it is shown within the visualizer section 220. For example, if one of the components 280 comprises a purse, and the purse component is selected within the classification tree 200, the purse is shown in the visualizer section 220, as shown in FIG. 2. It should also be appreciated that the classification tree 200 may be expanded or compressed as desired by selecting an expander 282.

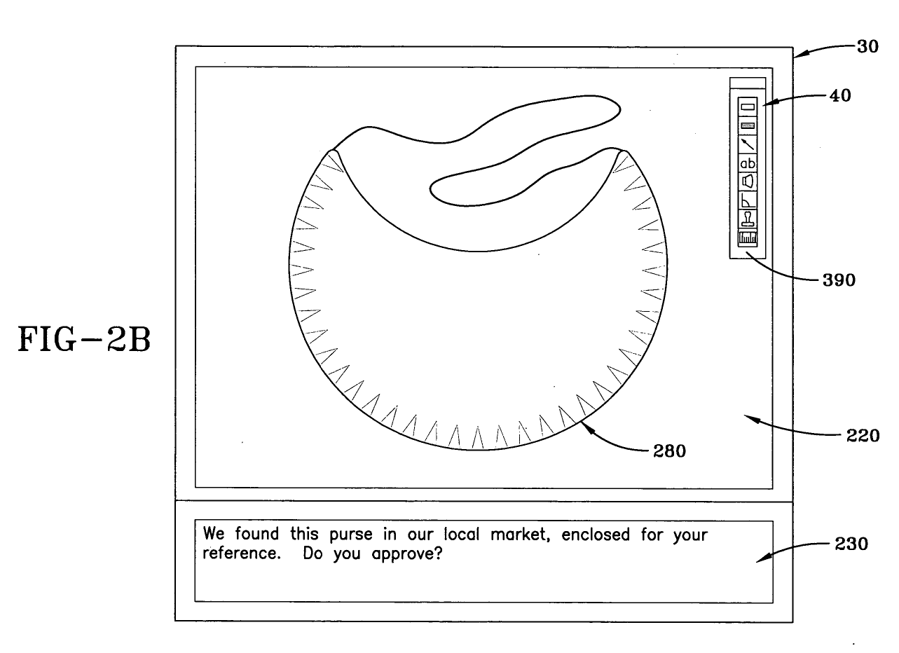

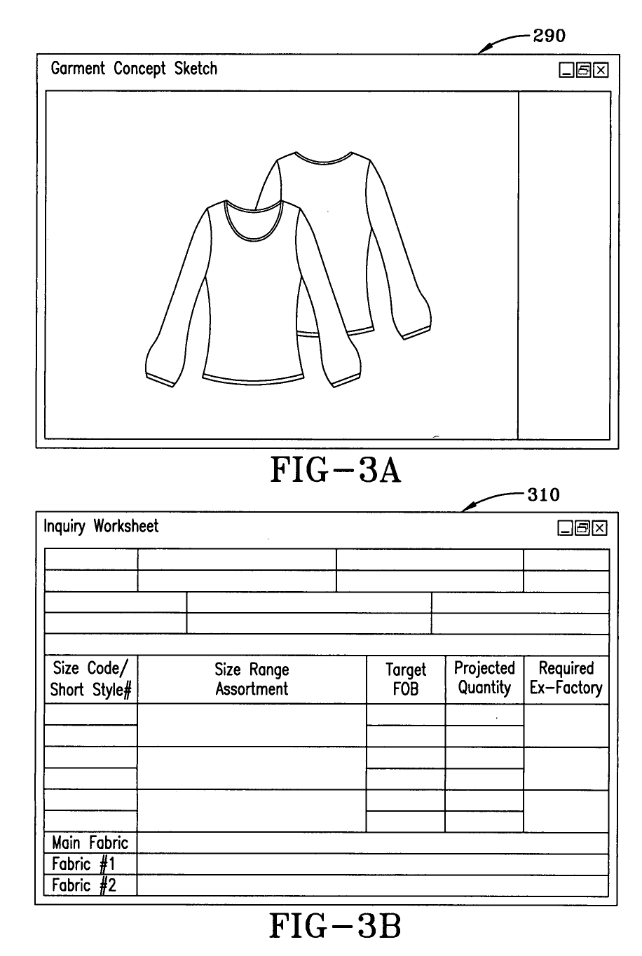

It should also be appreciated that the garment identifier 260 may also include a conceptual sketch file 290, a color standard file 300, and an inquiry worksheet file 310. Shown in FIG. 3A, the conceptual sketch file 290 is a computer data file that comprises a drawing that is produced, typically by the brand designer 12A, to illustrate the desired design of a garment. The sketch file may include any number of views such a front and back. The inquiry worksheet file 310, shown in FIG. 3B comprises a spreadsheet that is developed by the brand designer 12A, which identifies the components 280 of the garment, as well as the specifications and attributes that the garment is to include. For the purposes of clarity, the conceptual sketch file 290 and the inquiry worksheet file 310 together form a new order inquiry (NOI). The standard color file 300 allows the production department 12D producing the garment to match the garment colors to a standard color set, such as the Pantone Color classification.

It should also be appreciated that particular collection identifiers 250, garment identifiers 260, component identifiers 270, and garment components 280 maintained by the GCK-DB 80 may be searched by keyword or other criteria using a search field 309 provided by the GDF browser 30. As such, the user can quickly find data regarding a particular design project quickly and readily.

The parameters section 210 of the GDF browser 30 provides various details of a particular component 280 selected by the user within the classification tree 200 and selected by the user. For example, the user of the GDF browser 30 may select, using the computer mouse or any suitable input device, any desired component 280 within the classification tree 200 in order to view additional information associated with the selected component 280. Specifically, the parameters section 210 provides an attribute field 320 and a value field 322. The attribute field 320 includes one or more attributes associated with the component 280, while the value field 322 provides characteristics 324 that describe the particular attribute identified in the attribute field 320. In one embodiment, the attribute field 320 may include a type attribute 330 which is associated with the particular type of component 280 that is selected; a price attribute 332 that identifies the price of the selected component 280; a quantity attribute 334 that identifies the quantity of the component 280 used in the garment; and a location attribute 336 that identifies the where the component 280 is oriented with regard to a body form when the completed garment 260 is worn. It should be appreciated that the attributes contained within the attributes section 320, and the particular characteristics 324 in the value field 322 associated therewith are stored in the GCK-DB 80 of the primary data repository 20.

The visualizer section 220 of the GDF browser 30 provides the user with a region in which a particular component 280, selected within the classification tree 200, may be visually displayed so as to give the user an indication of how the component 280 appears. For example, as previously discussed, if a purse is provided within the classification tree 200 as a garment component 280, then a sketch or photo of the purse is presented in the visualizer section 220. In addition, the visualizer section 220 may also provide audio clips and video clips that provide additional information regarding the selected component 280. In addition to the ability to view a selected component 280, the visualizer section 220 also provides a region that allows for a user to view computer data files, such as spreadsheets to facilitate the calculation of materials requirement, aggregation and distribution of component workload, and price calculations and checklists. For example, the user may view the inquiry worksheet 310 associated with any selected component in the visualizer section 220 if desired.

The comment box 230 of the GDF browser 30 provides the supply chain members 12A-D with a text field in which he or she may enter text-based comments relating to the garment under development. For example, the comment box 230 may allow text, as well as audio-based comments to be stored at the GCK-DB 80 for subsequent viewing or listening by any of the members 12A-D of the supply chain. As such, when collaborative communication is taking place between multiple members 12A-D of the supply chain, knowledge can be effectively disseminated as well as retained as it is compiled. In addition, the comments presented in the comment box 230 are stored and displayed when the particular garment 260 or garment component 280 is accessed via the GDF browser 30. Furthermore, each member 12A-D of the manufacturing supply chain has access to the same comments, thereby facilitating the communication therebetween. Furthermore, the comment box 230 allows various data file attachments, such as garment data files, to be attached within the comment box section 230 by one member 12A-D for viewing by any other member 12A-D. Thus, any information or data disposed within the comment box section 230 is stored at the GCK-DB 80 for subsequent review by any of the supply chain members 12A-D using the GDF browser 30. It should also be appreciated that the comment box section 230 may also include a history section (not shown) that accumulates each comment made by the members 12A-D of in the comment box section 230.

The GDF browser 30 also includes an import option 350, an export option 352, a split option 353, and an email option 354 that may be selected by the user as desired. The import option 350, when selected, allows other garment data from another GDF file to be appended to the currently opened classification tree 200 if desired. In addition, the export option 352 also allows subordinate sections of the classification tree 200 of a currently opened GDF file to be stored in a new GDF file. A split option 353 enables the user to break the classification tree 200 of a currently opened GDF file into a plurality of sub-trees as desired. The email option 354, when selected is configured to launch a suitable email client program that enables the user to send email messages to any desired individual, including members 12A-D of the garment supply chain. It should be appreciated that the term GDF file refers to any electronic data file, such as garment data files, that may be accessed by any of the browsers, workstations, applications or any other component of the system 10.

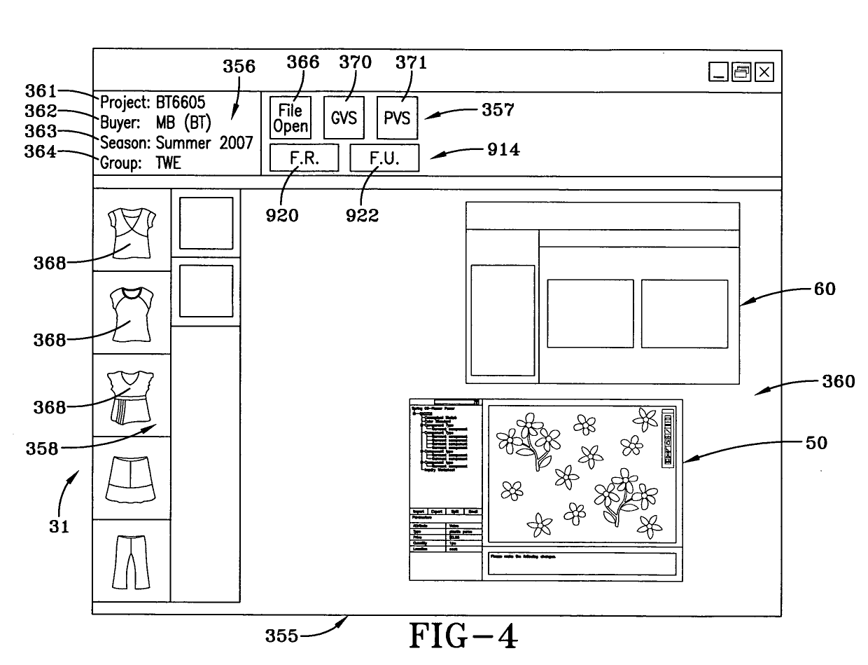

In conjunction with the GDF browser 30, the GDF workstation 31 may also be used. In one aspect, the GDF browser 30 may be presented on one computer display, such as a liquid crystal display, and the GDF workstation 31 may provide its own display, such as liquid crystal display, so as to provide a dual-display system. In addition, the GDF workstation 31 includes a computer system that includes suitable input devices, such as a keyboard and computer mouse to allow the user to interact. Thus, the information presented by the GDF browser 30, and the GDF workstation 31 complements each other, and enables the user to more efficiently access garment related information as the garment development process progresses. As shown in FIG. 4, the GDF workstation 31 includes a screen 355 that displays a data section 356, an application toolbar 357, a thumbnail browser 358, and an imaging section 360. It should be appreciated that the screen 355 may be rendered from software compatible with that of the computer comprising the workstation 31.

The data section 356 includes a project field 361, a buyer field 362, a season field 363, and a group field 364. Specifically, the project field 361 displays the particular project to which the currently opened GDF file that is being accessed from the primary data repository 20 belongs. The buyer field 362 displays the specific member 12A that is purchasing the garment to be manufactured. The season field 363 displays the particular season to which the garment that is under development belongs. The group field 364 displays the particular group code to which the particular garment is associated. The toolbar 357 contains various options, such as a file open option 366 that when selected allows a user to select and open a particular GDF file stored in the primary data repository 20. In addition, the toolbar 357 may also include a GVS option 370 and a PVS option 371 that when respectively selected launches the GVS application 50 and the PVS application 60. It should also be appreciated that the toolbar 357 may provide various shortcuts to invoke various other commonly used applications such as the a web browser, the annotations application 40, word processors, spreadsheet applications, voice conferencing applications, or any other computer application. The thumbnail browser 358 includes a plurality of thumbnail images 368 that are associated with the particular GDF file having the project file name shown in the project field 361. For example, the thumbnail images 368 may comprise garment images, which when selected are shown in the imaging section 360. Next, the imaging section 360 provides a region for viewing various spreadsheets, worksheets, garment images, and also provides a region for displaying the images generated from the GVS application 50, the PVS application 60 or any other desired browser, application, or image.

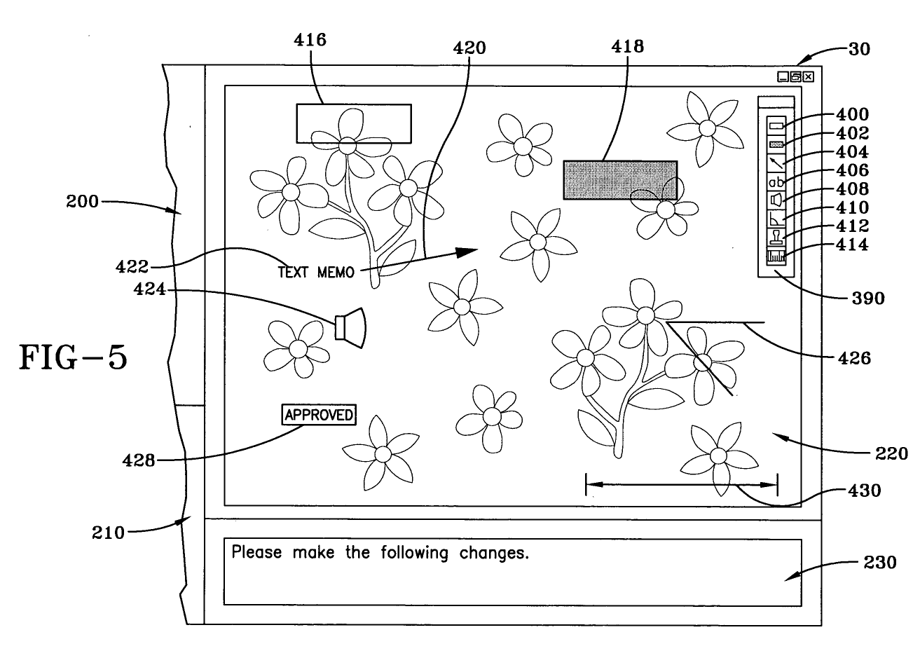

In addition to the GDF browser 30, and the GDF workstation 31, the garment development and production system 10 also includes the annotation application 40, shown in FIG. 2 that is used in conjunction with the GDF browser 30. The annotations application 40 provides a set of tools that allows any member 12A-D of the supply chain to provide comments, and other graphical notation within the visualizer section of the GDF browser 30. As such, the annotation application provides a medium for graphically communicating a message, comment, or other indicia relating to any item of interest associated with the garment, or component that is displayed in the visualizer section 220 of the GDF browser 30. Specifically, as shown in FIG. 2 and more clearly in FIG. 5, the annotation application appears as an annotation toolbar 390 that is displayed in association with the GDF browser 30. It should be appreciated that the toolbar 390 may be launched as a separate program or may be incorporated into the functionality provided by the GDF browser 30. In particular, the annotation tool bar 390 includes a plurality of annotation options that include a shape option 400, a highlight option 402, a line/arrow option 404, a text memo option 406, an audio option 408, a protractor option 410, a stamp option 412, and a ruler option 414. The shape option 400 allows the user to draw various shapes 416, such as a rectangle for example, to provide emphasis and to direct the users attention to a particular region of concern on the selected garment 260 or garment component 280 shown in the visualizer section 220 of the GDF browser 30. The highlight option 402 provides a shaded area 418 that may be placed about any region of the garment 260 or component 280, to identify a particular region of concern. The line/arrow option 404 creates an arrow 420 pointing to a particular region of concern upon the garment 260 or component 280. In addition, the text/memo option 406 allows a user to enter text messages 422 within the visualizer section 220 of the GDF browser 30. Moreover, the text messages 422 may be positioned to any desired region of the visualizer 220 to provide added emphasis. For example, the text/memo option 406 may be used to provide a note or message indicating that the particular garment fabric is acceptable for use in the production of the garment. Additionally, the audio option 408 allows a user to record an audio message identified by an indicating icon 424, which when actuated allows subsequent playback. For example, the audio message could be used to indicate that the particular garment fabric is not acceptable. The protractor option 410 allows the user to visualize various angles by placing an arc segment 426 upon the item shown within the visualizer section 220. Next, the stamp option 412 provides one or more predetermined messages 428 that are automatically presented within the visualizer section 220 when the stamp option 412 is initiated. Finally, the ruler option 414 provides a visual depiction of a ruler 430 so as to allow the viewer to determine the relative size of the garment 260 or garment component 280 shown in the visualizer section 220.

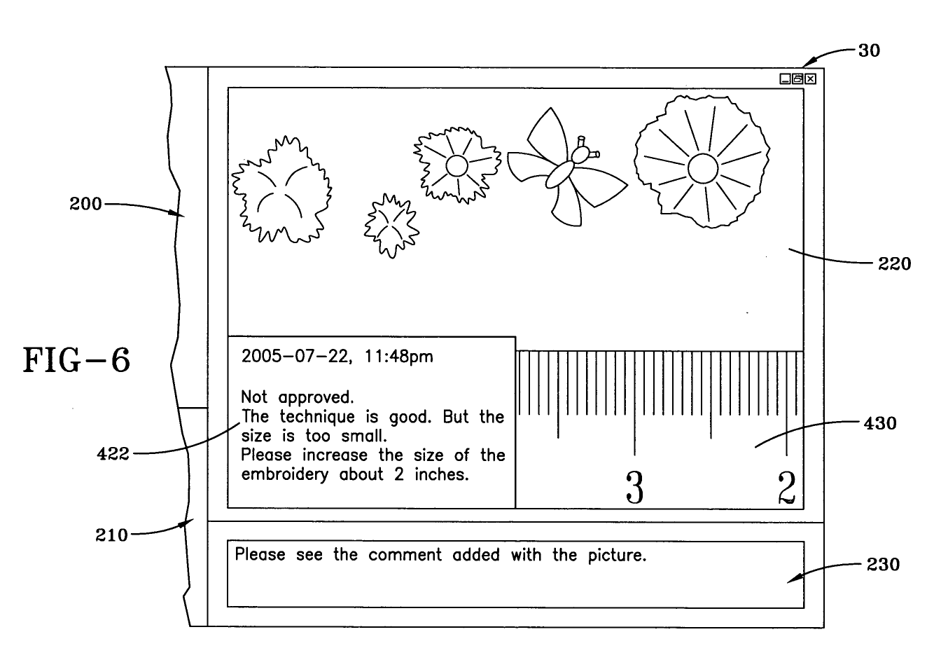

For example, FIG. 6 shows various annotations made using the text memo option 406 and the ruler option 414 provided by the toolbar 390 of the annotation application 40. In addition, the comment box section 230 may also be utilized to present text-based comments if desired. It should also be appreciated that the annotations made using the toolbar 390 are stored with the particular garment 260 or garment component 280 data file to which the annotation is made. For example, in FIG. 6, the text message 422 positioned about the embroidery component 280 shown in the visualizer section 220 of the GDF browser 30 becomes associated with the embroidery component 280 at the primary data repository 20. Thus, when a subsequent user accesses that same garment 260 or garment component 280, the text message 422 is still presented with the visual image of the selected garment or garment component in the visualizer 220.

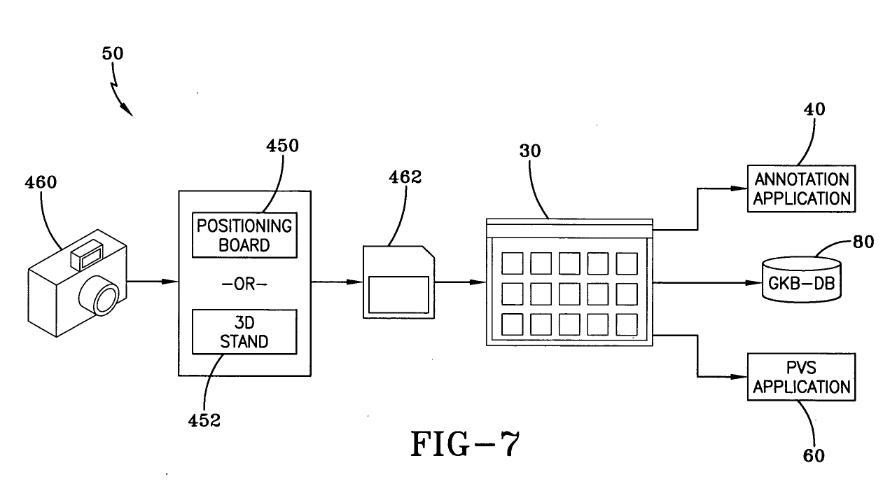

The GVS application 50, or garment visualization system, shown in FIG. 7, comprises several components, which enables a user to capture photo images of a garment and components thereof. Specifically, the GVS application 50 provides a positioning board 450 for taking two dimensional pictures of garments, and a stand 452 for taking three dimensional pictures of garments. The 3D dimensional stand 452 may include any desired body form upon which the garment may be fitted. In addition to the board 450 and stand 452, the GVS application 50 utilizes any suitable digital imaging system 460, such as a digital camera, which is enabled to take photos of the garments positioned upon the board 450 and stand 452. The images captured by the imaging system 460 may then be stored as digital image files on any suitable portable memory device 462, such as a flash memory card for example. The digital image files representing the garments that are stored at the portable memory device 462 are then imported into the GDF browser 30 using the import option 350. Once the digital image files are imported into the GDF browser 30, they may then be exported to the annotation application 40 for notation to support discussion between the supply chain members 12A-D, to the garment component knowledge data base (GCK-DB) 80 for storage and reference, or to the position verification system (PVS) application 60 for assessment upon various graphically rendered body forms. As such, the images collected by the GVS application 50 may be stored and utilized by any component of the garment development and production system 10, and by any member 12A-D of the garment supply chain as needed.

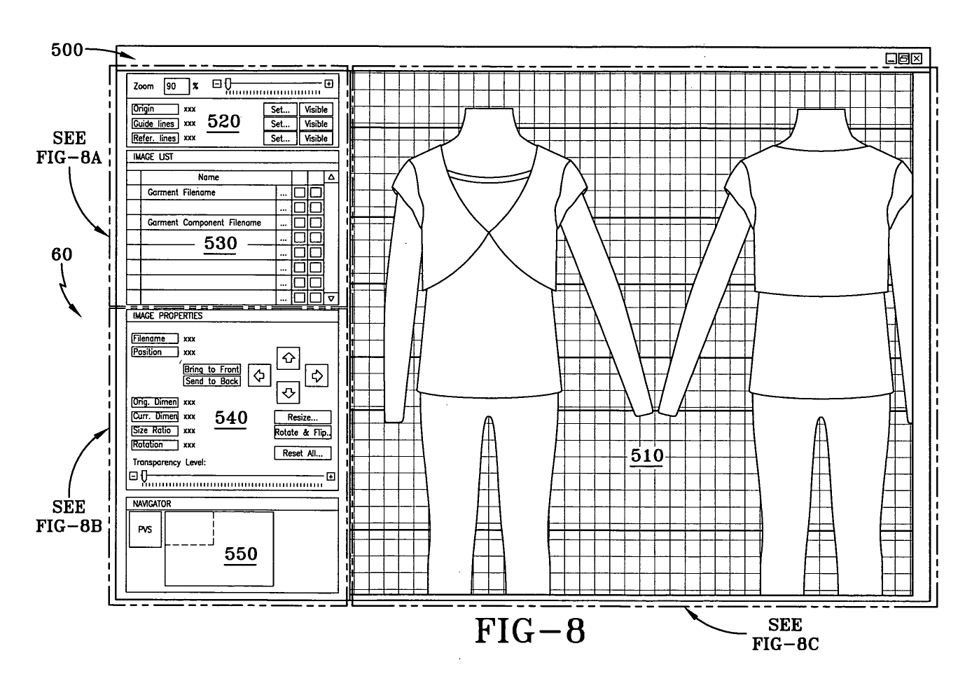

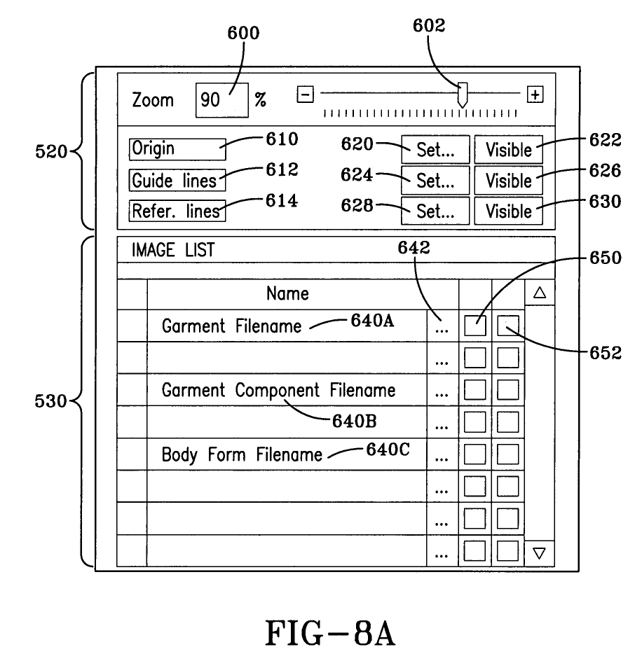

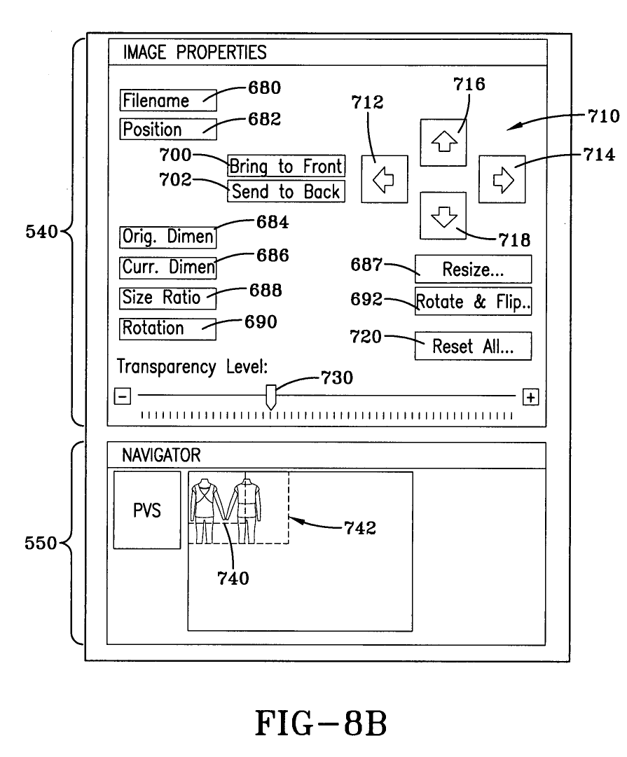

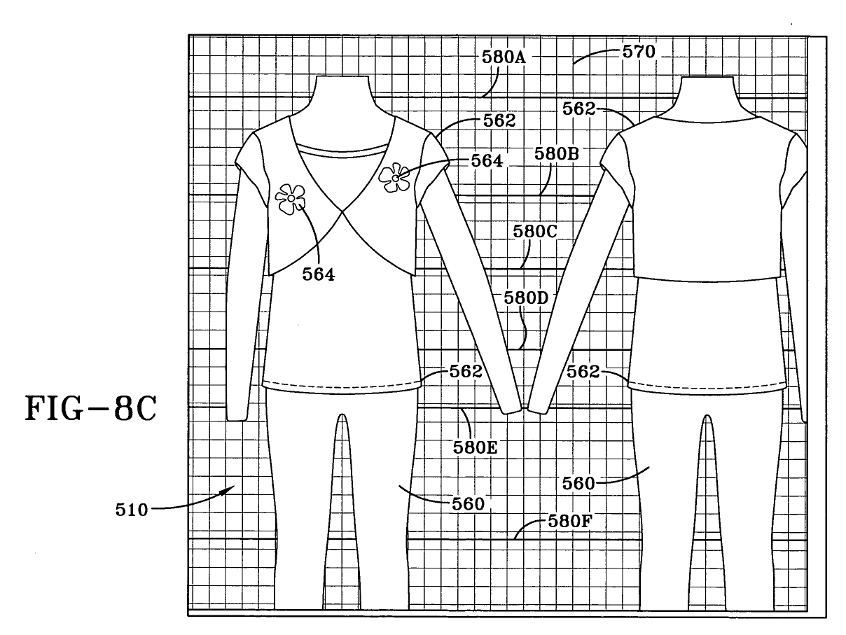

The position verification system, or PVS 60, as shown in FIG. 8, provides a PVS browser 500 that allows a user to manipulate the garment images received from the GVS application 50 or to manipulate the NOI sketches 290 created by the merchandiser 12B that have been imported via the GDF browser 30 and which are stored at the GCK-DB 80. It should be appreciated that the PVS browser 500 comprises a graphical user interface (GUI) that is rendered from software executed on a suitable computer system, such that the PVS browser is presented upon a viewable display, such as an LCD (liquid crystal display) for example. As such, the members 12A-D of the garment supply chain interact with the PVS browser 500 via any suitable input device, such as a mouse and/or keyboard for example. The PVS browser 500 may be configured as a standalone application that is launched separately from the GDF browser 30 and the other applications 40,50,60 discussed herein, or may be integrated into the GUI of the GDF browser 30 and launched by the selection of an associated icon for example.

Specifically, the PVS browser 500 includes an imaging section 510, a gridline adjustment section 520, an image list section 530, an image properties section 540, and a navigator section 550. The imaging section 510 provides a visual depiction of a selected body form 560 upon which the garment images 562 or garment component images 564 maintained by the GCK-DB 80 are to be fitted. Thus, the user is able to utilize the garment images or garment sketches maintained at the GCK-DB 80 with the PVS application 60, where the image or sketch may be superimposed upon the graphically represented body form 560 depicted in the imaging section 510. In one aspect, the particular body form 560 depicted in the imaging section 510 may be selected from the garment module database maintained by the GCK-DB 80. In addition to the body form 560, the imaging section 510 also includes a grid 570 and various reference lines 580A-F or “blue lines,” that are associated with specific positions on the body form 560, which are used to aid in the positioning of the garment or garment component upon the body form 560.

The PVS browser 500 also includes the gridline adjustment section 520, which allows the user of the PVS browser 500 to change the position of the grid 570 and/or the position of the reference lines 580A-F as well. Specifically, the gridline adjustment section 520 includes a zoom indicator-600 and a zoom slider bar 602. The zoom indicator 600 allows the user of the PVS application 60 to directly enter a desired level of zoom from 0 to 100% for viewing the garment images shown in the imaging section 510. Alternatively, the zoom slider bar 602 also allows the user to zoom in or out on items within the imaging section 510 by dragging the slider bar 602 from side to side via a computer mouse for example. The adjustment section 520 also includes an origin field 610, a gridlines field 612, and a reference lines field 614. The origin field 610 allows the user to establish the coordinates, using a set option 620, for the center of the gridlines 570 shown in the imaging section 510. In addition, a visible option 622 may be enabled so that the origin (not shown) is displayed, or may be disabled so that the origin is not displayed. The gridlines field 612 allows the user to set the height and width of the gridlines 570 by selecting a set option 624 and entering the desired values for the gridline width and height. Furthermore, a visible option 626 may be enabled so that the gridlines 570 are displayed, or may be disabled so that the gridlines 570 are not displayed. Additionally, the reference lines field 614 allows the user to enter values for establishing the position of the vertical position of the reference lines 580A-F. Such is done by selecting a set option 628, and entering desired values for the vertical position of each of the selected reference lines 580A-F. In addition, a visible option 630 may be enabled so that specific reference lines 580A-F may be displayed, or may be disabled so that particular reference lines 580A-F are not displayed.

The image list section 530 of the PVS browser 500 displays the particular file name of the garment 640A or garment component 640B that is being superimposed upon the body form 560. In addition, the image list section 530 may also include file names 640C of various body forms that may be used to replace the body form 560 presented in the imaging section 510. It should be appreciated that the garment file names 640A-C are retrieved from the GCK-DB 80 by selecting a file option 642. Although only three garment components are disclosed, any number could be provided. When the file option 642 is selected for a corresponding file name 640, the classification tree 200 is presented, enabling the user to select the desired garment 260, garment component 280 or other item such as alternative body forms which are displayed in the image list section 530. To facilitate the ability of the user to superimpose multiple garment images upon the body form 560, the image list section 530 also includes a hide option 650 and a lock option 652 that are associated with each garment file 640A-C. The hide option 650, when selected, causes the garment 562, garment component 564, or body form 560 associated therewith to be shown in the imaging section 510 of the PVS browser 500. Whereas, when the hide option 650 is not selected the garment 562, garment component 564, or body form 560 is not displayed in the imaging section 510. Once a desired positional relationship has been established between various garments 562 and 564 using the options provided by the image properties section 540 discussed below, the user may invoke the lock option 652. The lock option 652 allows the user to lock an established layered arrangement between any number of garments 562 and garment components 564, preventing them from being altered by any other member 12A-D of the garment supply chain.

In addition, the PVS browser 500 includes the image properties section 540, which allows a user to arrange a garment 562 or garment component 564 in a desired orientation upon the body form 560. Specifically, the image properties section 540 includes a plurality of fields that provides the user with various information concerning the garment or garment component selected by the user. Specifically, the image properties section 540 includes a filename field 680, a position field 682, an original dimension field 684, a current dimension field 686, a size ratio field 688, and a rotation field 690. The filename field 680 provides the filename 640A-C of the garment, garment component, or body form that the user has currently selected from the image list 530. The position field 682 displays the particular position of the garment or garment component with respect to the X and Y axis established by the grid 570. Next, the original dimension field 684 provides the width (W) and height (H) of the garment selected within the image list 530, while the current dimension field 686 provides the width (W) and height (H) of the garment after it has been resized. For example, the dimensions of the garment may be changed by the user via a resize option 687, which allows the user to define the particular width (W) and height (H) of the garment. The size ratio field 688 provides the width (W) and height (H) of the garment 562 or garment component 564 as a percentage. Finally, the rotation field 690 displays the number of degrees of rotation that the garment 562 or garment component 564 has been subjected to via the use of a rotate and flip option 692. It should also be appreciated that the rotate and flip option 692 also enables the user to flip, or otherwise toggle between the back and front regions of the garment 562 and/or the garment component 564. In addition, the image properties section 540 may also include a bring to front option 700 that allows the user to move a selected garment that is currently behind another garment 562 or garment component 564, to be brought in front of the other. Whereas a send to back option 702 allows a selected garment or garment components that is in front of another garment 562 or garment component 564 to be brought behind the other.

In addition, the horizontal and vertical position of the garment 562 or the garment component 564 may be changed by the actuation of a set of directional arrows 710. Specifically, the directional arrows 712 and 714 allow the garment 562 or the garment component 564 to be moved horizontally within the imaging section 510, while directional arrows 716 and 718 allow the garment 562 or garment group 564 to be moved vertically within the imaging section 510. A reset option 720 is also provided by the image properties section 540 that when selected allows the values for the original dimension 684, the current dimension 686, the size ratio 688, and the rotation 690 to be reset to default values.

A transparency level slider 730 provides the user with the ability to change the level of transparency of a selected garment 562 or garment component 564, so that the garments beneath the selected garment or the body form 560 may show through. This provides the user with the ability to readily view how the garment fits upon the body form 560.

The navigator section 550 provides a viewfinder 740 that may be positioned about a thumbnail image 742 of the garment 562 and garment components 564 shown in the imaging section 510. By moving the viewfinder 740 to a particular region of the thumbnail image 742, view of the garment 562 or garment component image 564 shown in the imaging section 510 may be altered so as to obtain a more precise view. This feature is beneficial in that the imaging section 510 may not be large enough to display each of the garments 562, garment components 564, and/or body forms 560 that are associated with a particular drawing or sketch loaded into the imaging section 510 of the PVS browser 500.

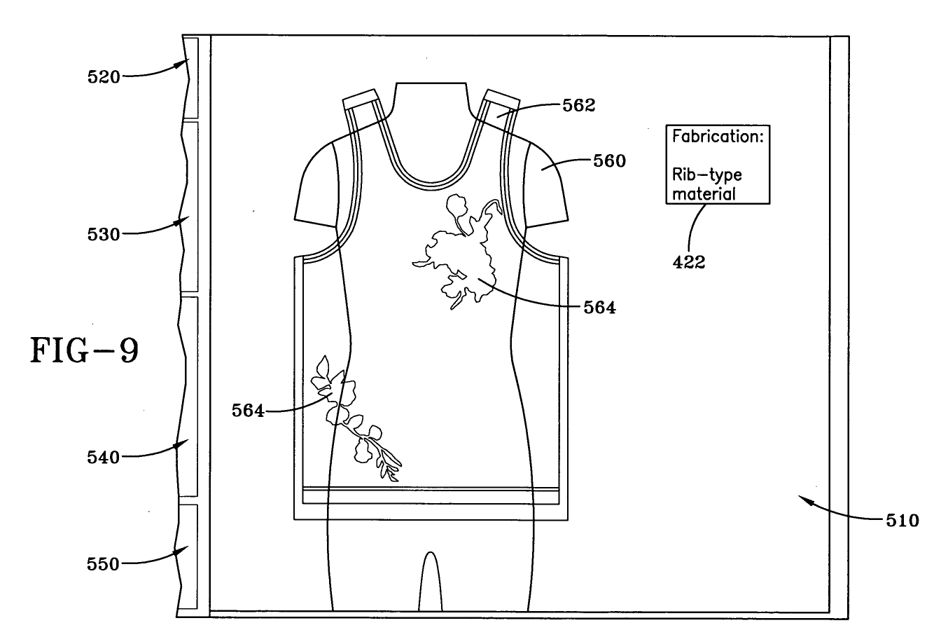

Thus, the PVS browser 500 enables the user to place a garment 562 and/or garment components 564 upon the body form 560, so as to allow the user to view how the completed garment would appear as it would be worn on an individual. For example, as shown in FIG. 9, the garment 562 is superimposed upon the body form 560, while the garment component 564, which is shown as an embroidery embellishment, is layered upon the garment 562.

In addition, the annotation application 40 may be used in association with the PVS application 60 so as to allow the user to make annotations or comments with regard to the positioning of the garment 562 and the garment component 564. For example, as shown in FIG. 8, the user may use the text memo tool 406 to provide a text message 422 indicating that the fabrication of the garment is formed from rib type material.

Thus, the GDF browser 30 and the annotation application 40, the GVS application 50, and the PVS application 60 coact to allow each member 12A-D of the garment supply chain to communicate garment data and collaborate as needed throughout the garment development process. That is, the brand designer 12A, the merchandiser 12B, the materials sourcing department 12C, and the sample/production department 12D may each collaborate with one another using the annotation toolbar 390, and the comment box section 230 of the GDF browser 30. And each member 12A-D may share garment data throughout the development of a particular garment design using the GDF browser 30 and the primary data repository 20. In addition, the knowledge that is created due to the collaborative discussions is archived at the GCK-DB 80 of the primary data repository 20 so that that it can be subsequently accessed by any of the members 12A-D of the garment supply chain. Thus, the garment development and production system 10 retains the knowledge developed during the development of a garment, allowing such knowledge to be accessed as needed to enable members 12A-D of the garment supply chain to overcome future technical impediments associated with subsequent garment design.

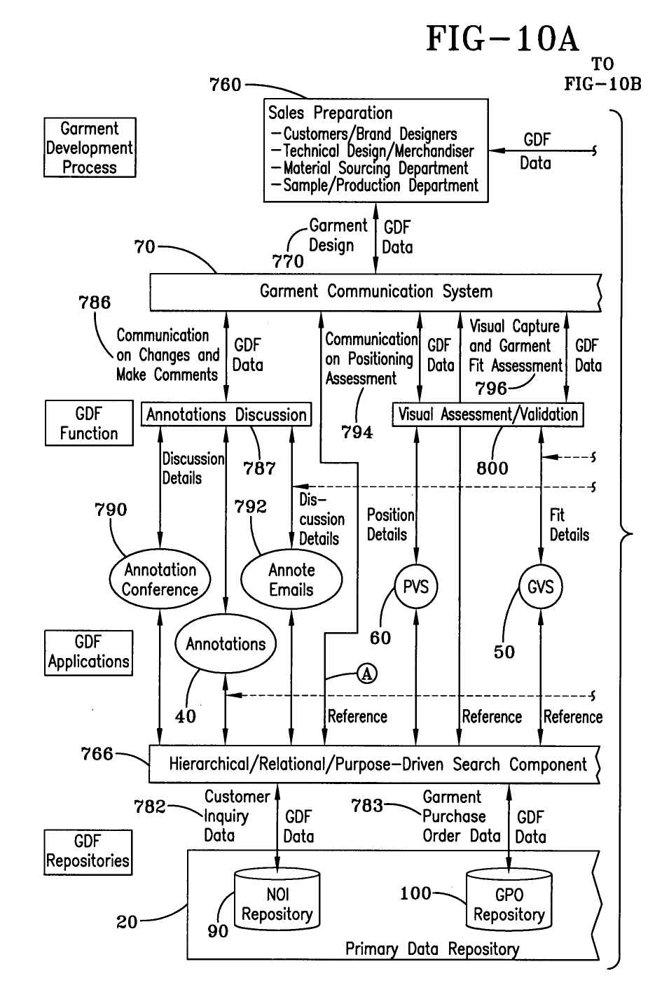

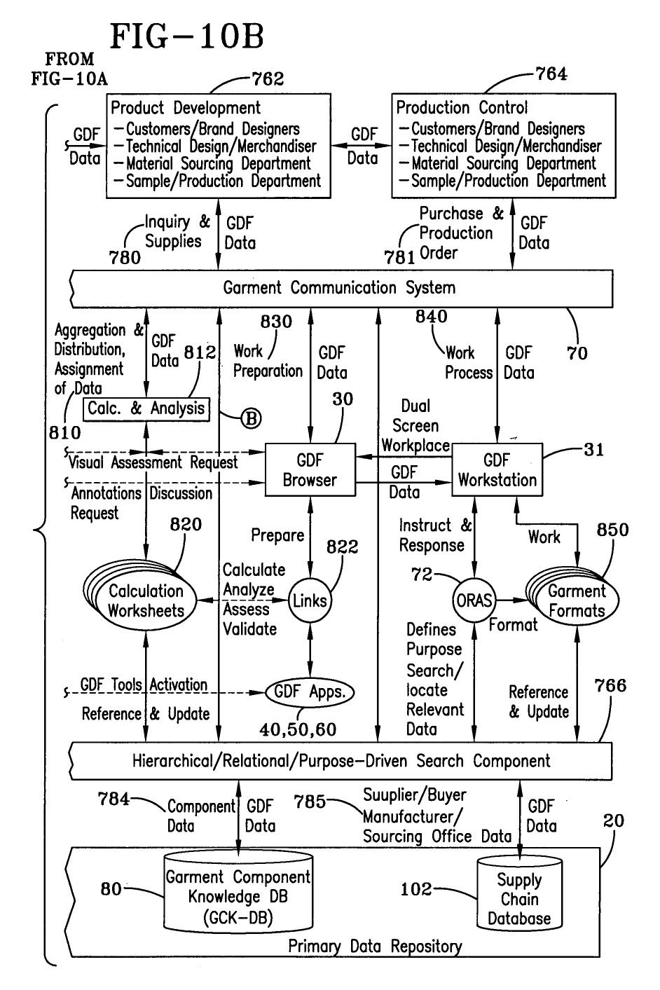

FIG. 10 shows the purpose-driven interaction of the members 12A-D with the various applications provided by the garment development and production system 10. Thus, the members 12A-D are enabled to accomplish specific tasks or to fulfill particular purposes, which arise throughout the various phases 760,762,764 of the garment development process. In other words, at each phase of the garment production process, the members 12A-D may supply and retrieve garment data from the garment communication system 70. Specifically, the garment communication system 70 maintains communication links with the GCK-DB 80, the NOI repository 90, the GPO repository 100, and the supply chain database 102 which comprise the primary data repository 20. A hierarchical/relational/purpose-driven search component 766 maintained by the communication network 70 is interfaced between the various applications, browsers, and workstations and the primary data repository 20 to enable members 12A-D to access/reference, store, and update the garment data stored at the primary data repository 20.

In particular, during the sales preparation phase 760, the members 12A-D may communicate garment design data 770 into the garment communication network 70. Furthermore, at the product development phase 762, the members 12A-D may communicate order inquiry data and sample data 780 into the garment communication network 70. Thus, the garment design data 770 and the order inquiry/sample data 780 may be supplied to or retrieved from the garment communication system 70 by the use of any of the GDF browser 30, or the GDF workstation 31. In addition, garment purchase and production order data may be communicated into the garment communication network 70 by any of the members 12A-D. It should also be appreciated that the garment design data 770, the inquiry/sample data 780, and the purchase and production order data 781 may be accessed from the primary data repository 20 as needed by the members 12A-D via the various communication links designated “A” and “B”. Moreover, each of the members 12A-D may communicate with each other using the browsers, workstations, and applications provided by the garment development and production system 10.

In addition to the information communicated by the members 12A-D into the network 70, the primary data repository 20 also supplies garment data to the various members 12A-D via the various browsers, workstations, and applications provided by the garment development and production system 10. Specifically, the NOI repository 90 provides customer inquiry data 782, the GPO repository 100 supplies garment purchase order data 783, the GCK-DB 80 supplies component data 784, and the supply chain database 102 supplies supplier/buyer/merchandiser/sourcing department data 785.

Should any member 12A-D desire to communicate a change or make any desired comment 786 to any other member 12A-D regarding the garment design data 770 or the inquiry/sample data 780, as indicated at 782, an annotations discussion 787 may be invoked. The annotations discussion 787 includes a variety of applications that enable the members 12A-D to collaborate and communicate garment data. In one aspect, the annotations discussion 787 may include an annotation conference 790, which allows two or more members 12A-D to interactively share annotations with each other in real-time, using the annotation toolbar 390 via their respective GDF browsers 30, while talking together on a telephone or other voice communication system. The annotations discussion 787 may also take the form of annotated emails 792, which may contain various garment image files or garment data files, such as GDF files that have been marked-up with annotations using the annotations toolbar 390, and sent as attachment files between the various members 12A-D as desired. Finally, the annotations discussion 787 may utilize the annotations toolbar 390 with the GDF browser 30 to make annotations with regard to a particular garment image file, such that the annotations are reflected in an updated garment image file stored at the primary data repository 20. As such, when another member 12A-D accesses the updated garment image file, the annotations are shown. Moreover, as shown in FIG. 10, the annotations, made via the annotation conference 790, the annotated email application 792, or the annotations application 40, are all stored at the primary data repository 20 and accessed via the garment communication system by the search component 766 using the GDF browser 30.

Should any member 12A-D desire to assess the positioning of a garment image upon a graphically rendered body form 794, a visual assessment and validation process 800 may be performed. The visual assessment and validation process 800 utilizes the PVS application 60, which allows the members 12A-D to view a particular garment image that is superimposed upon a graphical body form image in the manner previously discussed above. Moreover, as shown in FIG. 10, the particular positioning of the garment image upon the body form image using the PVS application 60 may be stored in the primary data repository 20, where it may be later retrieved for review by another member 12A-D.

Additionally, should any member 12A-D desire to visually capture an image of a garment or conduct a garment fit assessment, the GVS application 50 may be invoked. As shown in FIG. 10, the garment images resulting from the use of the GVS application 50 may be stored in the primary data repository 20, where they may be later retrieved for review by another member 12A-D.

Furthermore, should any member 12A-D desire to aggregate, distribute, or assign garment data 810, such as the purchase and production order data 781, a calculation and analysis function 812 may be utilized. The calculation and analysis function 812 may be invoked by any member 12A-D of the garment supply chain 12A-D. As such, various calculation worksheets 820 obtained from the primary data repository 20 may be accessed by the GDF browser 30 via database links 822. The calculation worksheets may comprise a spreadsheet that may be interacted with by the members 12A-D using the GDF browser 30. Any changes or modifications made to the worksheets 820 is updated within the worksheets 820 and is stored at the primary data repository 20.

If the members 12A-D desire to engage in work preparation 830, the GDF browser 30 is utilized. As previously discussed, the GDF browser 30 enables the members 12A-D to prepare garment work, and as such the GDF browser 30 may through the database links 822 obtain data from various worksheets 820. In addition, the GDF browser 30 may send visual assessment requests to the GVS application 50 to acquire various garment images therefrom. Also, requests for discussion with another member 12A-D by annotated emails 792 may be received or initiated by the GDF browser 30.

Additionally, if the members 12A-D desire to engage in work process 840, the GDF workstation 31 is utilized. Specifically, the GDF workstation 31 communicates with the ORAS 72. As previously discussed, the GDF workstation 31 is a computer system with suitable input devices that is utilized by the members 12A-D throughout the various stages of the garment development process. In particular, the GDF workstation 31 enables the calculation, analysis, performance evaluation, assessment, and validation of garment data using various spreadsheets, as well as the GVS and PVS applications 50,60. It should also be appreciated that that the workstation browser 31 also is in communication with the ORAS 72, which defines the purpose and provides the workflow platform to allow the members 12A-D of the garment supply chain to issue instructions and receives responses throughout the garment development and production process. In other words, the ORAS 72 defines the purpose for accessing information from the primary data repository 20 and/or the purpose for engaging in a collaborative communication during the garment development process. Specifically, the ORAS 72 defines the purpose, and enables the search and location of relevant data maintained by the primary data repository 20. In addition, the ORAS 72 may also acquire garment formats 850 as needed. It should be appreciated that during the garment sample development and production control there are many factors and variables that affect the calculation and analysis of various calculation worksheets, including garment purchase orders (GPOs). In one aspect, the garment formats 850 may comprise various calculation formats, analysis formats, and assessment/validation formats to be discussed. For example, specific calculation formats are provided by the system 10 to guide the calculation of the material requirements for a group of garment purchase orders (GPOs). After various calculations-have been performed, the user then analyzes the results using a calculation/analysis format that arranges the GPO data, including the quantity of materials required in order to determine if a particular delivery date can be satisfied. In addition to calculations and analysis, the user may need to visually assess the garment images associated with a particular GPO, using the GVS 50 and the PVS 60 applications. The garment formats 850 may also include an assessment/validation format that provides a checklist for assessing that the garment images provided by the GVS 50 and PVS 60 satisfy certain criteria. Furthermore, the assessment/validation format may be used for validating that the garment design is correct.

While the discussion of FIG. 10 describes the relationships between the various components of garment development and production system 10 and the manner of communication utilizing such system, the discussion that follows relates to the utilization of the ORAS 72 during the production control phase 764 of the garment production process. In particular, production control phase 764 may be associated with the steps taken to purchase fabric and planning/loading the sewing plant with sewing workloads for the production of a particular garment or groups or collections of garments.

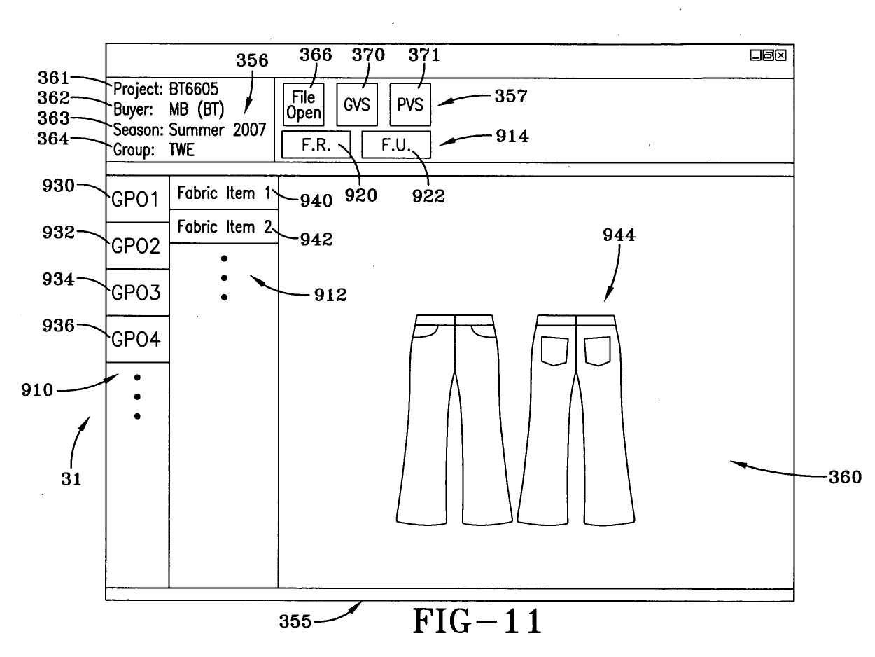

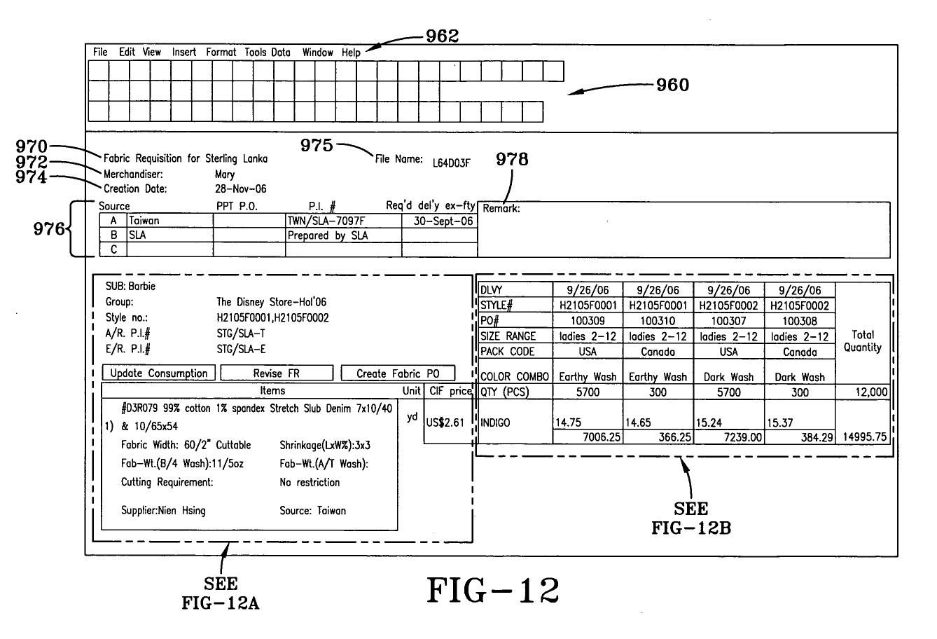

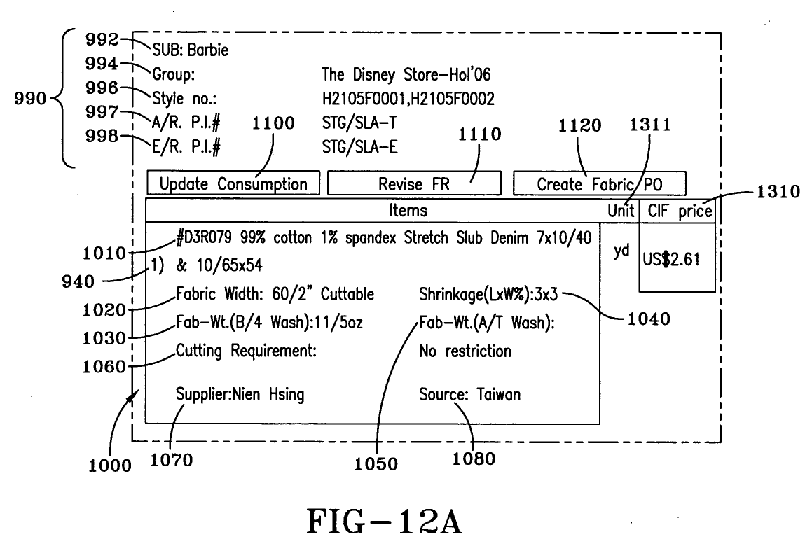

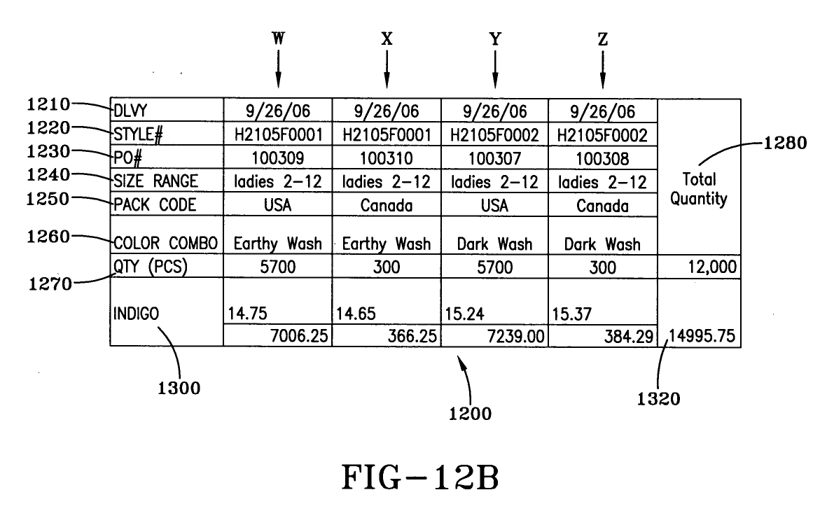

Thus, in regard to fabric purchase orders or FPO's the GDF workstation 31 is utilized, and presents an updated workstation screen 355 and a fabric requisition worksheet, or FRW 902, as shown in respective FIGS. 11 and 12. The updated workstation screen 355, shown in FIG. 11, includes the data section 356, the toolbar 357, and the imaging section 360, but also includes a GPO (garment purchase order) list 910, and an associated fabric item list 912 in lieu of the thumbnail browser 358 shown in FIG. 4. Furthermore, the updated workstation screen 355 also includes a material control toolbar 914 that includes a user selectable fabric requisition option, or F.R. option 920, and a fabric utilization option, or F.U. option 922. The F.R. option 920 can be selected by the user to identify the particular fabric needed to produce a group of orders at production time for a particular customer 12A. The F.U. option 922 when selected allows the user to monitor and control the usage of the fabric selected by the F.R. option 920. As such, the F.R. option 920 and the F.U. option 922 allows the user to control the fabric material designated for a group of garment purchase orders (GPOs). Thus, the workstation screen 355 allows each GPO 930,932,934,936 to be listed, and each fabric item or component associated with a selected GPO 930,932,934,936 to be shown in the fabric item list 912. For example, if the user selects the GPO1 930 from the GPO list 910, fabric item1 940 and fabric item2 942 are displayed in the fabric item list 912. Once the list of fabric items 940,942 is displayed in the fabric item list 912, the user may select any fabric item from the fabric item list 912 for display in the imaging section 360. For example, if the user selects the fabric iteml 940, the fabric item, such as front and rear view of a pair of pants 944, will be shown in the imaging section 360.

From the workstation screen 355 of the GDF workstation 31, the user may select the F.R. option 920 to launch the fabric requisition worksheet (FRW) 902 within the imaging section 360 of the GDF workstation 31, as shown in FIG. 12. The worksheet 902 may comprise any suitable spreadsheet configured in the manner to be discussed. Specifically, the FRW 902 includes a menu 960, and one or more tool bars 962 that enable the user to perform one or more functions associated with the data input into the worksheet 902. In addition, the FRW 902 includes a title section 970 to display the particular name of the entity requisitioning the fabric, and a merchandiser section 972 indicating the name of the individual employee initiating the fabric requisition. In addition, the FRW 902 also includes a worksheet creation date section 974 to display the date when the FRW 902 was created, and a filename section 975 to display the particular file name associated with the FRW 902 so that it can be located at the GCK-DB 80. The FRW 902 also includes a fabric source section 976 that provides various information regarding the particular entities from which fabric is being requested, a remarks section 978 allows the user to enter any desired alphanumeric message or comment as desired. Furthermore, a garment GPO information section 990 is provided by the FRW 902, which displays specific information regarding the particular GPO garment for which the fabric identified by the FRW 902 is needed. For example, the GPO garment design information section 990 may include a SUB section 992, a group section 994 indicating the garment group or collection to which the garment is associated, a style no. section 996, a A/R P.I. # section 997, and a E/R P.I.# section 998. Specifically, the A/R P.I.# section 996 relates to the accessory requisition number, which relates to the accessories needed for a group of garment purchase orders (GPOs). The E/R P.I.# section 998 relates to the proforma invoice, which is an invoice that enables the recipient to use when applying for the customs declaration in order to import the materials.

The FRW 902 also includes a fabric information section 1000, which provides various information regarding the particular fabric item identified. For example, the FRW 902 shown in FIG. 12 relates to fabric item1 940, which is also referenced to the workstation screen 355 previously discussed. In particular, the fabric information section 1000 includes a fabric description section 1010 which describes the particular specifications of the fabric being requested as part of the fabric requisition worksheet 902. For example, the fabric information section 1010 may comprise a serial number, and the constituent materials that make up the fabric item 940, although any description may be provided. In addition, the fabric information section 1000 may also include a fabric width section 1020, a fabric weight before washing section 1030, a shrinkage section 1040, and a fabric weight after washing section 1050. The fabric width section 1020 presents the particular width dimension of the fabric item 940, whereas sections 1030 and 1050 provide the weight of the fabric before and after washing. The shrinkage section 1040 also gives the percentage of shrinkage in length and width dimensions that the fabric item 940 may encounter due to washing. In addition, the fabric information section 1000 may also include a cutting requirement section 1060, which indicates whether any special handling is needed in cutting the fabric item 940. Furthermore, the fabric information section 1000 also includes a supplier section 1070 to indicate the name of the supplier of the fabric item 940, while a fabric source section 1080 identifies the geographical origin of the fabric item 940.

In addition, the fabric requisition worksheet 902 also includes an update consumption option 1100, a revise FR (fabric requisition) option 1110, a create fabric PO (purchase order) option 1120, that may be invoked by the user of the FRW 902. The update consumption option 1100, when selected, allows the user to update the quantity of fabric needed for a particular garment purchase order (GPO). Next, the revise fabric requisition option 1110, when selected, allows the user to lock or unlock the FRW 902. That is, when the FRW 902 is locked, changes may not be made to any of the sections of the FRW 902, however, when the FRW 902 is unlocked changes may be made to any of the sections of the FRW 902 as desired. Finally, the create fabric PO (purchase order) option 1120, when selected, allows the user to generate a fabric purchase order, which can be forwarded to the fabric manufacturer.

Another portion of the FRW 902 is a data region 1200, which comprises a group of data records that include a delivery date record 1210, a style # record 1220, a PO # (purchase order #) record 1230, a size range record 1240, a pack code record 1250, a color combo record 1260, and a qty (pcs) record 1270. As such, the records 1210-1270 describe a specific individual fabric purchase order (PO) as identified by the columns W, X, Y, and Z. It should be appreciated that while four purchase orders (PO's) are described in the FRW 902, that the FRW 902 may be used to describe any number of purchase orders.

In particular, the delivery date record 1210 identifies the date on which the fabric item 940 is to be delivered, and the style # record 1220 indicates the particular code associated with the garment to be manufactured using the fabric item 940. Furthermore, the PO # record 1230 indicates the unique purchase order number associated with each purchase order of fabric item 940 to be requisitioned. Next, the size range record 1240 presents the size range for the garments being produced, while the pack code record 1250 indicates where the garments are to be shipped after they are produced. The color combo record 1260 provides a brief description of the particular visual characteristics of the particular garment. Furthermore, the qty (pcs) record 1270 identifies the specific quantity of garments to be manufactured, while the total number of garments to be produced for each PO# is shown in a total quantity column 1280.

Furthermore, the FRS 902 also includes a marker name record 1300, which indicates the marker value for each of the PO#'s in the columns W, X, Y, Z in the data region 1200. Associated with the marker name record 1300 is a CIF price field 1310, which indicates the cost of the fabric item 940 per unit as indicated at a unit field 1311. As such, the data region 1200 allows the fabric requirements for a particular garment purchase order (GPO) to be aggregated. Thus, the product of the marker values in each column W, X, Y, Z with the respective quantity values in each column W, X, Y, Z may be calculated and summed in order to obtain a fabric order quantity total 1320. Thereby aggregating the fabric requirements for a particular fabric requisition.

Thus, it is apparent that the use of ORAS 72, which implements the FRS 902 and the workstation screen 355, during the fabric purchasing phase of the garment production process allows the user to aggregate the fabric order details according to brand, season, and group. ORAS 72 also allows the user to instruct the pattern department to generate an estimate marker, while also allowing the FRW (fabric requisition worksheet) 902 to be created. After the FRW 902 has been created, a fabric purchase order may be generated using the create fabric PO option 1120. As such, material control during the production of a garment, allows the individual responsible for the purchase of fabric to verify the target fabric quantities required for a particular garment design. In addition, the target fabric quantity can be later compared with the actual quantity of fabric delivered for performance evaluation.

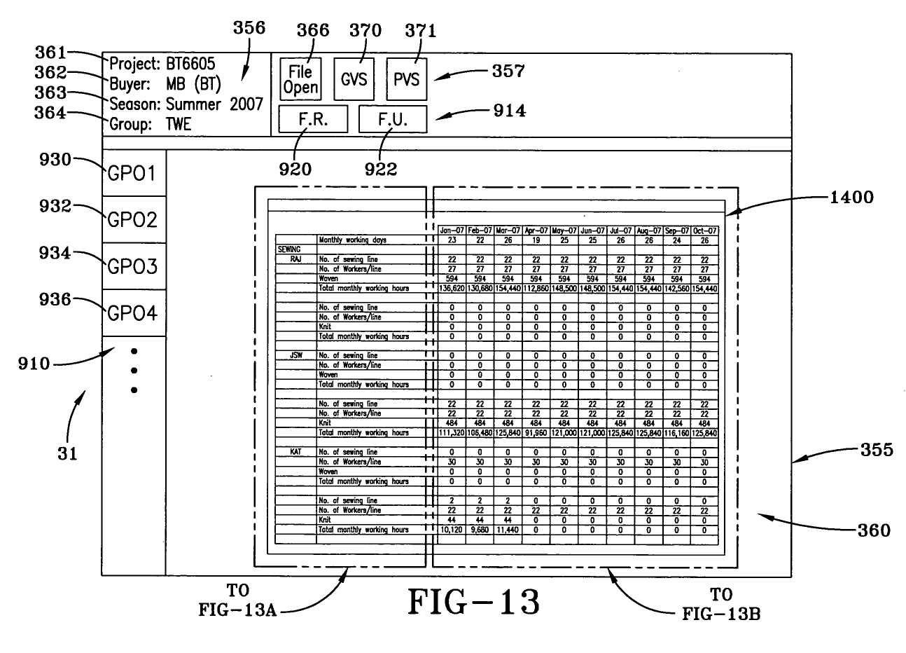

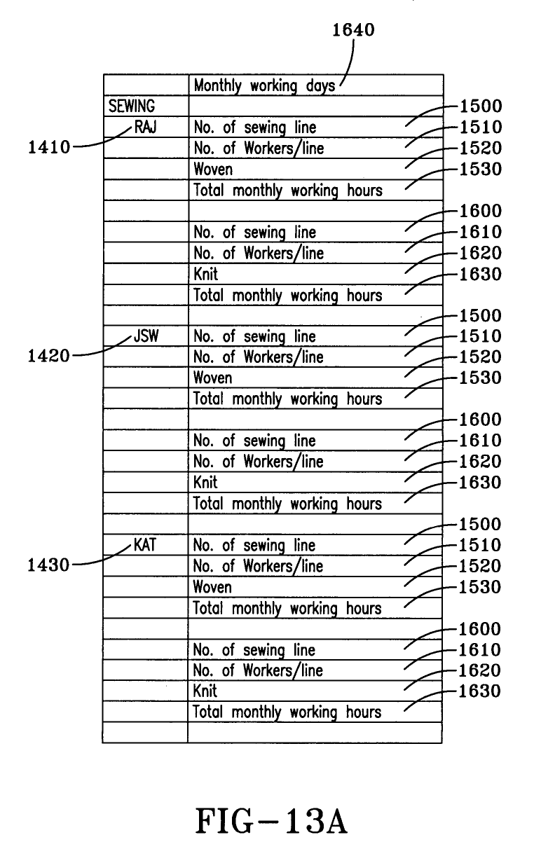

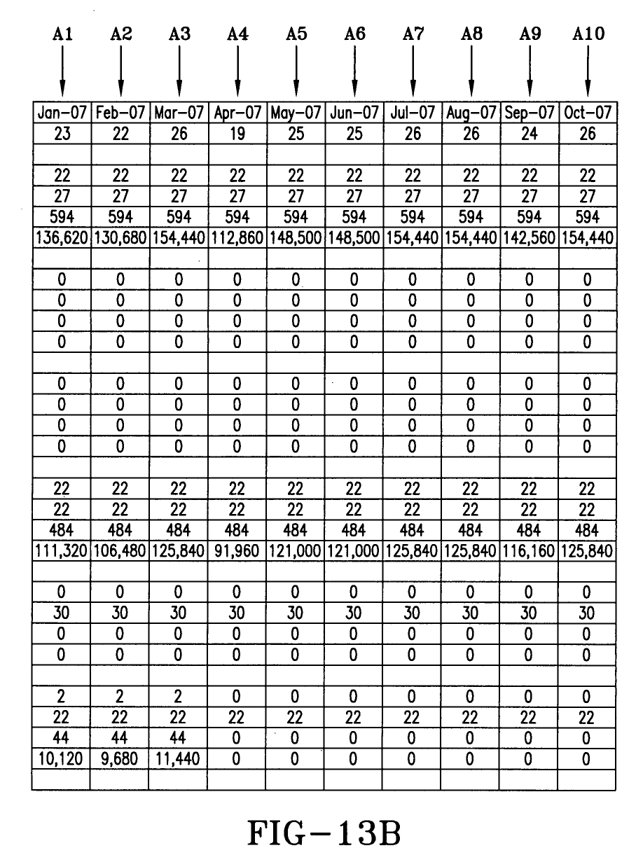

Once the fabric has been obtained using the procedures discussed above, the process of sewing the individual fabric items together to form the completed garment is carried out. To maintain control over the sewing aspect of garment production, a sewing construction control for sewing factor loading is implemented. Specifically, the sewing control is implemented using the workstation screen 355, which presents a sewing control worksheet 1400 that is presented within the imaging section 360, as shown in FIG. 13. It should be appreciated that the worksheet 1400 may comprise any suitable spreadsheet that is configured in the manner to be discussed. The sewing control worksheet 1400 includes a plurality of sections 1410, 1420, and 1430 that are associated with a sewing factories. Within each section 1410-1430 are a plurality of records that are associated with knit and woven garments, although other classification based on sewing technique, or any other classification could be used. Specifically, each section 1410-1430 contain the following woven related records: No. of sewing lines 1500, No. of workers/line 1510, number of woven garments 1520, total monthly working hours 1530. And with respect to knit garments the sections 1410-1430 include the following records: No. of sewing lines 1600, No. of workers/line 1610, number of knit garments 1620, total monthly working hours 1630. Each of the records 1500-1530 and 1600-1630 are broken down by month across a plurality of columns indicated as A1-A10. In addition, each of the columns A1-A10 includes the number of monthly working days as identified by the monthly working days record 1640.

Thus, by selecting a particular GPO entry 930-936 from the GPO list 910 of the workstation screen 355, the sewing control worksheet 1400 lists the SAH (standards allowable hour) and the various sewing production statistics associated with the selected GPO entry. In particular, the SAH is an indication of workload quantity, which is used to calculate the amount of work necessary to accomplish a particular job or task.

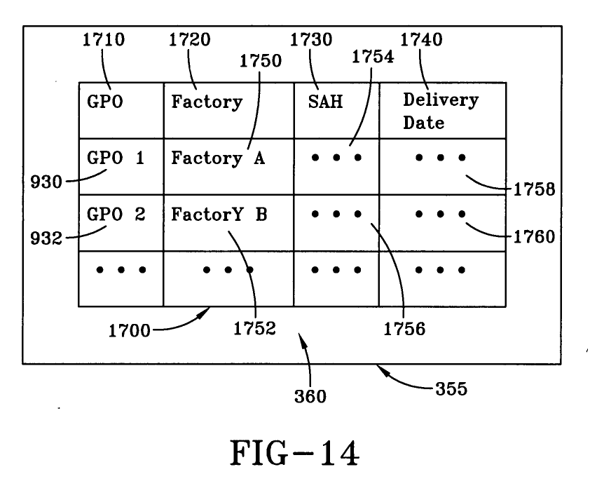

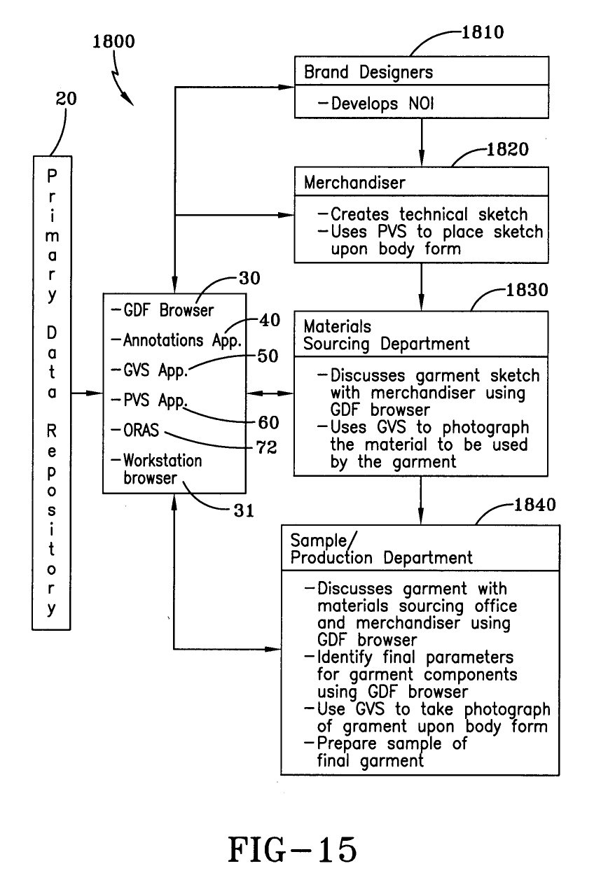

In conjunction with the sewing control worksheet 1400, a production worksheet 1700, shown in FIG. 14 may be presented within the imaging section 360 of the workstation screen 355. The production worksheet 1700 comprises a GPO section 1710, a factory section 1720, a SAH section 1730, and a delivery date section 1740. The GPO section 1710 indicates the various GPO's 930,932, and their particular association with factory 1750,1752, particular SAH 1754,1756, and delivery date 1758,1760. As such, the production worksheet 1700 and the sewing control worksheet 1400 may be used by the sewing manager to distribute the workload to different production lines according to the capability and capacity of each line. Furthermore, the line supervisor can assign of each GPO to the line worker according to the worker's skill level and efficiency.

The operational steps utilized by the garment development and production system 10 implementing the GDF browser 30, the GDF workstation 31, the workstation browser 31, the annotation application 40, the GVS application 50, and the PVS application 60 to conceive and produce a garment are generally referred to by the numeral 1800 as shown in FIG. 11 of the drawings. In addition, during the performance of the operational steps 1800, each of the members 12A-D of the garment supply chain are able to access garment data stored at the primary data repository 20 using the GDF browser 30 and/or the worksheet browser 31. And are also able to collaborate with each other in the manner previously discussed at any time during the performance of the operational steps 1800.

Initially, at step 1810, the creation of a garment is initiated by the brand designer 12A by the submission of the NOI or new order inquiry to the merchandiser 12B. The NOI, as shown in FIGS. 3A and 3B, includes the sketch 290 and the spreadsheet 310, which includes the specifications of the garment that is desired to be produced. For example, the specifications associated with the garment that are identified in the NOI may include: the type of fabric to be used, the type of trim to be used, the type of accessories to be used, as well as any other detail or specification associated with the garment desired to be produced.

Next, at step 1820, the sketch 290 and the inquiry sheet 310 is received by the merchandiser 12B for review. The merchandiser 12B then creates a technical sketch of the garment, and defines the particular components of the garment and imports them into the classification tree 200 of the GDF browser 30 using the GVS application 50. That is, each component of the garment is identified in the classification tree 200, which is stored at the garment component knowledge database GCK-DB 80. Thus, storing the garment component data at the GCK-DB 80 allows the members 12A-D of the supply chain to have access to the garment data at any time, including during a collaboration session between the supply chain members 12A-D. The merchandiser 12B also utilizes the GDF browser 30 and the PVS application 60 to position the garment image upon the body form 560 within the imaging section 510. This allows all members 12A-D of the supply chain to view a graphical rendering of the garment as it would be worn by a potential purchaser of the garment.

Once the merchandiser 12B completes the sketch and has identified the specifications of the garment and the garment components, the materials sourcing department 12C is consulted using the GDF browser 30 and the applications 40-60, as indicated at step 1830. Specifically, the merchandiser 12B and the materials sourcing department 12C may collaborate using the tools provided by the GDF browser 30, the annotation application 40, the GVS application 50, and the PVS application 60. For example, the merchandiser 12B and the materials sourcing department 12C may collaborate using the text memo tool 406 of the annotation application 40 to create a variety of text memos identifying particular concerns or questions the members have. In addition, the materials sourcing department 12C may use the GVS application 50 to generate digital images of the various fabrics that are to be used to produce the garment under consideration, and which are imported into the GCK-DB 80 for access by all of the supply chain members 12A-D. Next, at step 1840, the sample/production department 12D of the supply chain may discuss any technical questions with the materials sourcing department 12C and the merchandiser 12B, as well as with the brand designers 12A using the comment box section 230 or the annotation application 40. As such, the final attributes entered into the attribute field 320 and the related attribute values 322 associated with each garment component 280 shown in the classification tree 200 are finalized in the parameter section 210 of the GDF browser 30. Next, the sample/production department 12D may obtain images of the completed garment sample or garment component sample using the GVS application 50 and importing them into the GCK-DB 80 using the GDF browser 30. Finally, the images captured by the GVS application 50 may then be accessed by the other members 12A-C of the supply chain for review and/or for discussion.

Although, the following discussion sets forth one manner of communicating between each of the members 12A-D of the supply chain, it should be appreciated that the supply chain members 12A-D may communicate garment data and collaborate interactively with each other using the GDF browser 30 at any point in the garment development and production process.

It will, therefore, be appreciated that one advantage of one or more embodiments of the present invention is that a garment production system includes a garment data format (GDF) browser that utilizes a standardized data format for enabling members of a garment supply chain to collaborate. Another advantage of the present invention is that the garment production system provides a garment component knowledge database (GCK-DB) that is configured to store the collaborative data associated with the development of a garment. Still another advantage of the present invention is that the garment production system provides an annotations application that allows the members of the garment supply chain to provide graphical comments with respect to the various components of a garment being developed. An additional advantage of the present invention is that the garment production system includes a garment visualization system (GVS) application that allows the members of the garment supply chain to capture images of the garment components as they are fabricated, so as to enable the discussion thereof. Another advantage of the present invention is that the garment production system includes a position verification system (PVS) that enables the members of the garment supply chain to position graphical renderings or sketches of the garments or garment components upon various body forms to determine if the garment or garment component correctly fits.

Although the present invention has been described in considerable detail with reference to certain embodiments, other embodiments are possible. Therefore, the spirit and scope of the appended claims should not be limited to the description of the embodiments contained herein.

What is claimed is:

1. A graphical user interface including a display and a selection device, a method of providing and selecting from a browser on the display, the method comprising:
retrieving a classification tree section, a parameters section, and a visualization section for the browser;
displaying said classification tree section on the display, said classification tree including at least one garment component entry associated with a garment component image, an attribute and an attribute value maintained at a database;
displaying said parameters section on the display;
displaying said visualization section on the display; and
receiving a first selection signal indicative of the selection device pointing at a selected garment component entry included at said classification tree;
wherein in response to said first selection signal, said parameters section displays said attribute and said attribute value, and said visualization section displays said garment component image.

2. The graphical user interface of claim 1, further comprising:
retrieving a comment section;
displaying said comment section on the display;
entering comment data into said comment section;
storing said data at said garment component knowledge database; and
associating said comment data with said selected garment component entry.

3. The graphical user interface of claim 1, further comprising:
displaying an annotations toolbar on the display, said toolbar having at least one annotation option; and
receiving a second selection signal indicative of the selection device pointing at a selected comment option;
wherein in response to said second selection signal a comment indicia is displayed on the display in said visualization section.

4. The graphical user interface of claim 3, further comprising:
storing said comment indicia at said garment component knowledge database; and associating said comment indicia with said selected garment component entry.

5. The graphical user interface of claim 1, further comprising:
displaying a search field on the display;
entering search criteria into said search field;
searching said database for garment component entries associated with said criteria; and displaying the results of said searching step.

6. The graphical user interface of claim 1, wherein said at least one garment component entry is arranged hierarchically in said classification tree.

7. The graphical user interface of claim 1, further comprising:
displaying an import option on the display; and
receiving a second selection signal indicative of the selection device pointing at said import option;
wherein in response to said second selection signal, garment data is stored at said database.

8. The graphical user interface of claim 1, further comprising:
displaying an export option on the display; and
receiving a second selection signal indicative of the selection device pointing at said export option said export option;
wherein in response to said second selection signal, garment data stored at said database is transferred to a storage unit.

9. The graphical user interface of claim 1, wherein said database comprises a knowledge base.

10. A graphical user interface including a display and a selection device, a method of providing and selecting from a browser on the display, the method comprising:
retrieving an imaging section, an image list section, and a body form image;
displaying said imaging section on the display;
displaying said body form image in said imaging section, wherein at least one reference line is located a first position with respect to said body form image;
displaying said image list section, said image list section including at least one garment component entry associated with a garment image maintained at a garment component knowledge database;
receiving a first selection signal indicative of the selection device pointing at a selected garment component entry, wherein in response to said first selection signal, said imaging section displays said selected garment image; and
positioning said garment image upon said body form image.

11. The graphical user interface of claim 10, further comprising:
retrieving an image properties section;
displaying said image properties section on the display, said image properties section including a plurality of directional indicator; and
receiving a second selection signal indicative of the selection device pointing at a selected directional indicator;
wherein in response to said second selection signal, said garment image is moved with respect to said body form in the direction indicated by said selected directional indicator.

12. The graphical user interface of claim 10, further comprising:
displaying a transparency level indicator having a plurality of transparency levels; and
receiving a second selection signal indicative of the selection device pointing at a selected transparency level;
wherein in response to said second selection signal the transparency of said garment image is changed.

13. The graphical user interface of claim 10, further comprising:
displaying a reference line set option on the display; and
adjusting said set option so that at least one of said at least one reference line is moved to another position with respect to said body form image.

14. A method for collaborating and sharing garment data among a plurality of members of a garment supply chain comprising:
providing a primary data repository, wherein each of said members communicate with said data repository via a browser;
importing a garment image into said browser;
storing said garment image at said repository;
positioning said garment image with respect to a body form image retrieved from said data repository; and
storing said positioned garment and body form image at said repository as a garment data file.

15. The method of claim 14, further comprising:
invoking an annotations option;
generating at least one annotation; and
associating said annotation with said garment data file.
